(19) United States
(12) Patent Application Publication
(10) Pub. No.: US 2015/0149298 A1
(43) Pub. Date: May 28, 2015

(54) DYNAMIC LIST CREATION

(71) Applicant: John Tapley, San Jose, CA (US)

(72) Inventor: John Tapley, San Jose, CA (US)

(21) Appl. No.: 14/530,458

(22) Filed: Oct. 31, 2014

Related U.S. Application Data
(60) Provisional application No. 61/908,020, filed on Nov. 22, 2013.

(51) Int. Cl. G06Q 30/06; G06Q 30/02

(52) U.S. Cl. CPC G06Q 30/0633; G06Q 30/0269
USPC 705/14.66; 705/26.8

(57) ABSTRACT

In various example embodiments, a system and method for dynamically creating an aggregate list are presented. For one embodiment, sensor data associated with a first data source type is received from a network. The sensor data represents at least one item to be added to the aggregate list from the first data source type representing a connected appliance. The aggregate list is associated with at least one user. The sensor data is processed based on predictive modeling associated with consumption of the at least one time to be added to the list to automatically generate learning data. The learning data is associated with a second data source type and representing at least one item to be added to the aggregate list from the second data source type. The non-sensor data associated with a third data source type is received from a network. The non-sensor data represents at least one item to be added to the aggregate list from the third data source type. An aggregate list is generated including a list of items from each of the first data source type, the second data source type and the third data source type.

### CROSS-REFERENCE TO RELATED APPLICATIONS

This application claims the benefit of U.S. Provisional Application No. 61/908,020, filed Nov. 22, 2013, entitled “DYNAMIC SHOPPING LISTS,” which is incorporated herein by reference in its entirety.

### TECHNICAL FIELD

This application relates to systems and methods for creating data sets or lists, and more particularly, not by way of limitation, to systems and methods of dynamically creating data sets or lists utilizing data from smart appliances and other data sources.

### BACKGROUND

Many people rely on lists to help them with their tasks. Manual entry may still be the most common way that people use to create lists. Electronic lists have several advantages over manual lists. For example, in one environment, an electronic shopping list may be able to provide an interface for price comparisons or product availability.

### BRIEF DESCRIPTION OF THE DRAWINGS

Various ones of the appended drawings merely illustrate example embodiments of the present disclosure and cannot be considered as limiting its scope.

FIG. 1A illustrates an example embodiment of a high-level block diagram of a connected system used to dynamically generate aggregate shopping lists.

FIG. 1B illustrates an example embodiment of a high-level client-server-based network architecture, according to an example embodiment.

FIG. 2A illustrates a block diagram showing components provided within a publication system, according to some embodiments.

FIG. 2B illustrates input data and output data for a learning machine and condition system, according to an example embodiment.

FIG. 2C illustrates input and output data for an inventory management system, according to example embodiments.

FIG. 2D illustrates a table of metadata fields and values for generating aggregate shopping lists, according to example embodiments.

FIG. 2E illustrates an aggregate list generation system receiving multiple data types from multiple data source types, according to an example embodiment.

FIG. 2F illustrates examples of data fields that may be included in a user interface (UI) displaying an aggregate shopping list.

FIG. 2G illustrates examples of data fields that may be included in a UI to help a user select recommended products from a number of merchants.

FIG. 3 illustrates a system for a client device running an electronic shopping list application to facilitate purchase transactions with a merchant system, according to an example embodiment.

FIG. 4 is a block diagram illustrating components of the inventory management application, according to some example embodiments.

FIG. 5A is a flow diagram illustrating an example method for automatically recommending a product to order based on an analysis of various data types from a variety of data source types.

FIGS. 5B-5D illustrate flow diagrams for various embodiments to dynamically generate aggregate shopping lists.

FIGS. 6A-6F illustrate example embodiments of UIs for displaying shopping lists.

FIG. 7 illustrates an example mobile device that may be executing a mobile operating system, according to example embodiments.

FIG. 8 is a block diagram 800 illustrating a software architecture used in a computing device or machine, according to example embodiments.

FIG. 9 is a block diagram illustrating components of a machine, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, systems and methods for utilizing data from smart appliances and other data sources to generate an aggregate list are described. In one example, in a publication system incorporating an online marketplace, an aggregate shopping list may be created and presented to a user on the user's client device through a web browser or application (app) installed on the user's client device. The products on the shopping list may be purchased online for in-store pick up or delivery, or purchased in a store from merchants within a network of affiliated merchants. The aggregate shopping list includes products added to the aggregate shopping list by multiple data source types. Examples of data source types include connected appliances, apps installed on a client device, a learning machine, or a condition system. The data from each of these data source types are combined in an intelligent manner to create an aggregate shopping list. The aggregate shopping list is an electronic shopping list that provides product information from one or more merchants within a network of affiliated merchants to help the user select specific products to purchase. The product information may include product description, brand, availability, price comparisons between matching products, and advertisement offers for the matching products. The products recommended may also be based on a user's profile, preferences, and historical transaction data for the products on the aggregate shopping lists. The aggregate shopping list may allow the user to place an order online directly from the aggregate shopping list for in-store pick up or delivery. The aggregate shopping list may keep the user informed with delivery information such as delivery status and estimated delivery time. Additionally, the aggregate shopping list may be used by a user while shopping in a physical store. While shopping in a physical store, the aggregate shopping list may show or highlight those products on the aggregate shopping list which are available from that physical store, and any coupons or advertising discounts offered by that physical store. The aggregate shopping list may also check off products that have been purchased from the shopping list and may alert the user when there are products from the shopping list that have not been purchased.

In accordance with one or more embodiments, a method for running an app on a client device to aid a user is disclosed. The application may be a shopping list app, a recipe app, or another type of app that allows lists to be created or provides an existing list that can be modified by one or more users. The app may be used by the user to add items to a shopping list. The same or different app may be used by the user to view an aggregate shopping list in which shopping list items added by a user are combined with shopping list items added by connected appliances, which can proactively detect that items need to be purchased based on detected situations within an environment, such as an in-home or office environment. The aggregate shopping list may also include shopping list items that were generated by a learning machine or condition system based on user specified data, sensor data from connected appliances, and metadata.

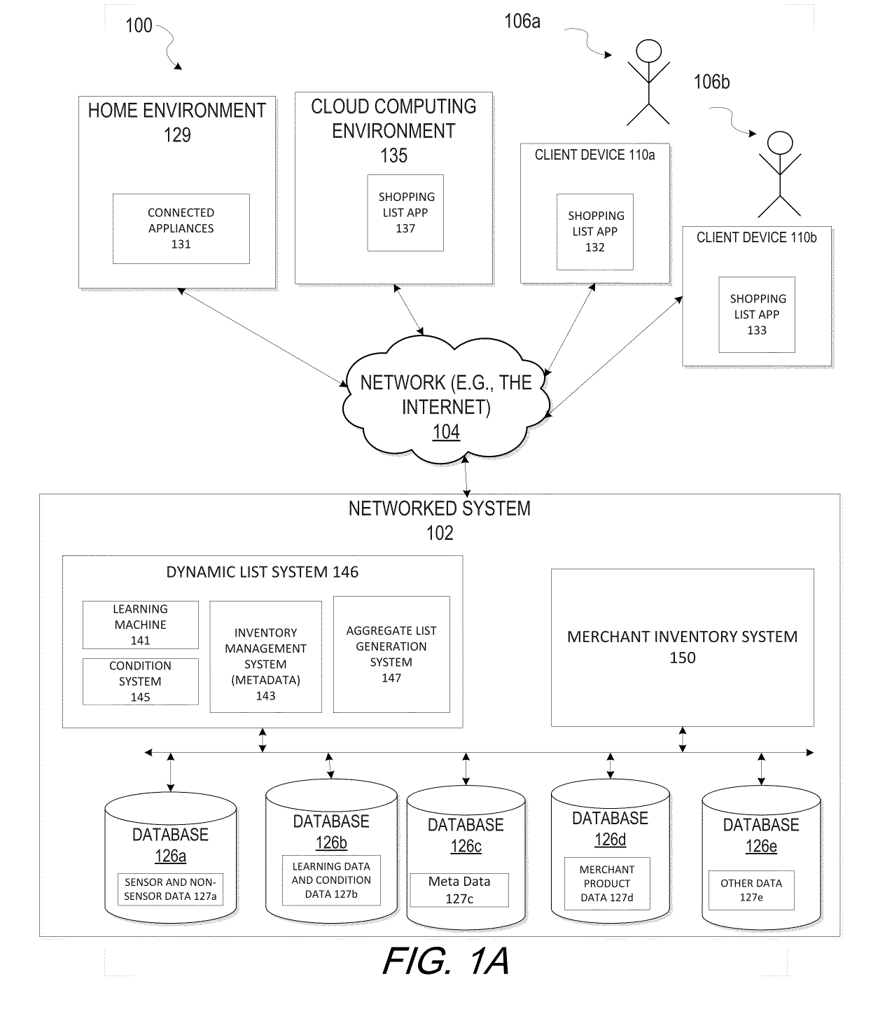

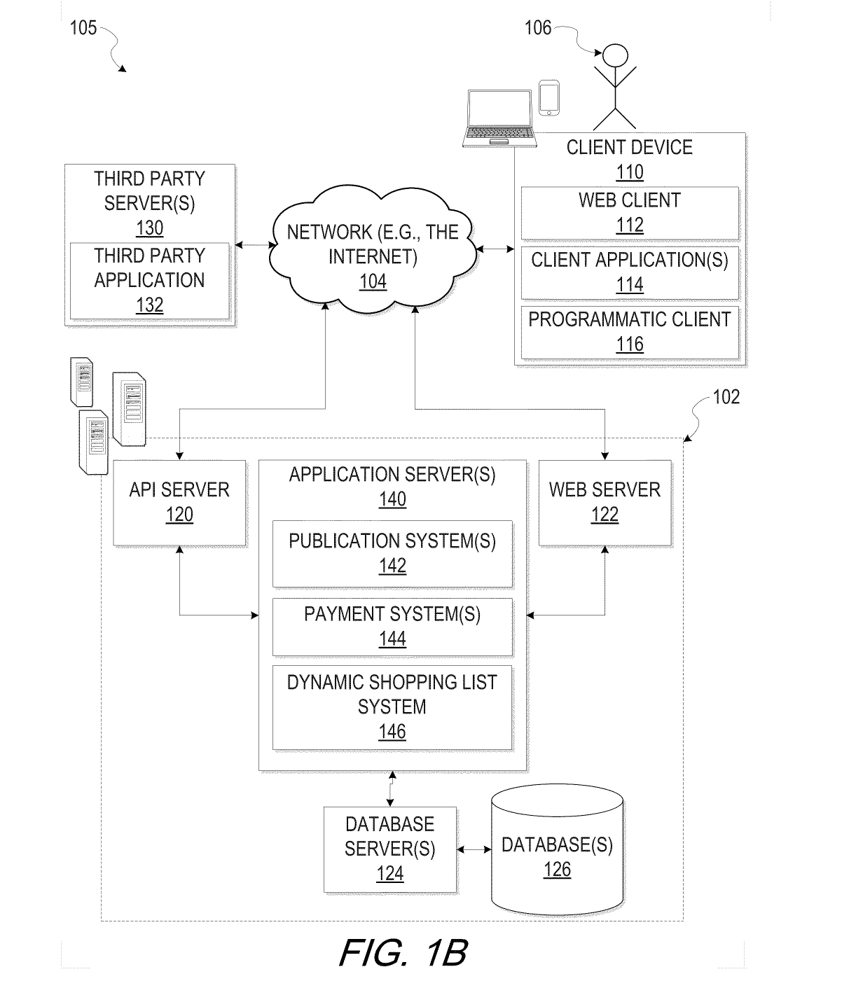

FIG. 1A illustrates an example embodiment of a high-level block diagram of a connected system used to dynamically generate aggregate shopping lists. The connected system 100 includes a home environment 129 having connected appliances 131. The connected appliances 131 represent smart appliances within the home environment 129, which are connected to a networked system 102 through a network 104. For example, the connected appliances 131 may be able to provide sensor data to the networked system 102 over the Internet. For alternative embodiments, the home environment may be replaced with another type of environment (e.g., office environment, club environment, or school environment) where connected appliances are available to provide sensor data. FIG. 1A illustrates a number of ways shopping list items may be added to an aggregate shopping list generated by the networked system 102. The aggregate shopping list may receive sensor data, non-sensor data, learning data, or condition data to dynamically create an aggregate shopping list from multiple data source types.

The networked system 102 may receive sensor data (directly or indirectly) from the connected appliances 131. The connected appliances 131 include sensors that detect changes in the home environment. In various embodiments, the sensor data is related to consumption of a product, or information that allows the connected appliances to infer consumption related information. For example, a smart refrigerator represents a connected appliance 131 having sensors such as cameras and scales. The refrigerator cameras may detect that a carton of milk has been removed from the refrigerator and returned to the refrigerator. Additionally, the refrigerator scale determines that the carton of milk is almost empty with only one quarter of the carton of milk filled. The smart refrigerator sends information (also referred to as sensor data) to the networked system 102 to add milk to the aggregate shopping list.

In various embodiments, the sensors detect when a grocery item, household item, or other item (collectively referred to as “products”) in the home environment 129 may need to be added to a shopping list. The sensors may detect when products may need to be ordered because the products have been consumed (or nearly consumed), need to be replaced (or replaced soon), or are expired (or about to expire). In various embodiments, the connected appliances 131 generate sensor data that is sent from the connected appliances 131 to the networked system 102 over the network 104. In example embodiments, the sensor data is sent directly to the networked system 102 without any involvement from users 106a or 106b before being added to the aggregate shopping list.

The home environment 129 may include any number of connected appliances 131. Some examples of smart appliances, which may be referred to as connected appliances 131 if connected to the network 104, include refrigerators, food pantries or pantry shelves, medicine cabinets, closets, washing machines, coffee makers, diaper bins, light bulbs, cars or other motor vehicles, smoke alarms, sprinklers, and various other kitchen or household appliances. Once the products are added to a shopping list, they may be referred to as a shopping list item.

Embodiments described herein may include utilizing data from connected appliances to automate, simplify, and facilitate various tasks. In an example embodiment, printers may automatically order ink cartridges when running low on ink, bathrooms may automatically order toiletries (e.g., toothpaste and toilet paper), fireplaces may automatically order logs, lamps and light fixtures may automatically order replacement bulbs, battery operated devices (e.g., smoke alarms, toys, flashlights) may automatically order batteries, washing machines may automatically order laundry detergent and fabric softener when running low, refrigerators may use scale and image recognition to automatically order out-of-stock items (e.g., milk and eggs), and cars may automatically schedule appointments for oil, battery, and tire changes.

In embodiments, sensors may be implemented throughout a home, building, car, lawn, appliances, and so forth. These sensors may be communicatively coupled to each other and to an application server or computer. For example, a lawn sensor or sensors may be embedded throughout the lawn to detect moisture. The lawn sensor may communicate moisture data to an application server. An application running on the application server may use the lawn sensor data to determine that the lawn may need to be watered. The application may then communicate with a sprinkler system to water the lawn. Many other sensors, conditions, and variations may be employed.

The networked system 102 may receive non-sensor data from a shopping list app 137 hosted within the cloud computing environment 135. The non-sensor data may represent user-specified data. Although two users (106a and 106b) are shown in FIG. 1A, any number of users may be associated with creating the aggregate shopping list. For example, a family of four may allow four users (e.g., mother, father, and two children) to add items to the family's aggregate shopping list by associating the four family members through their user accounts on the shopping list app 137.

The shopping list app 137 may be accessed by the users 106a or 106b via an app installed on the client devices 110a and 110b, respectively, or via a web browser application installed on the client devices 110a and 110b. For example, a user 106a or a user 106b may add items to a shopping list using shopping list app 132 and shopping list app 133, respectively. The shopping list app 132 may reside on the client device 110a and the shopping list app 133 may reside on the client device 110b, and provide accessibility to the shopping list app 137 within the cloud computing environment 135, where data for the shopping lists (or a copy of the shopping lists) created by users 106a and 106b may be stored. Data (e.g., the non-sensor data) stored within the cloud computing environment 135 may be retrieved by the networked system 102 to generate the aggregate shopping list. It should be noted that the non-sensor data is not limited to user specified input into a shopping list app. Various other types of apps may be used, for example, recipe apps or note taking apps such as Evernote, where lists may be created or modified.

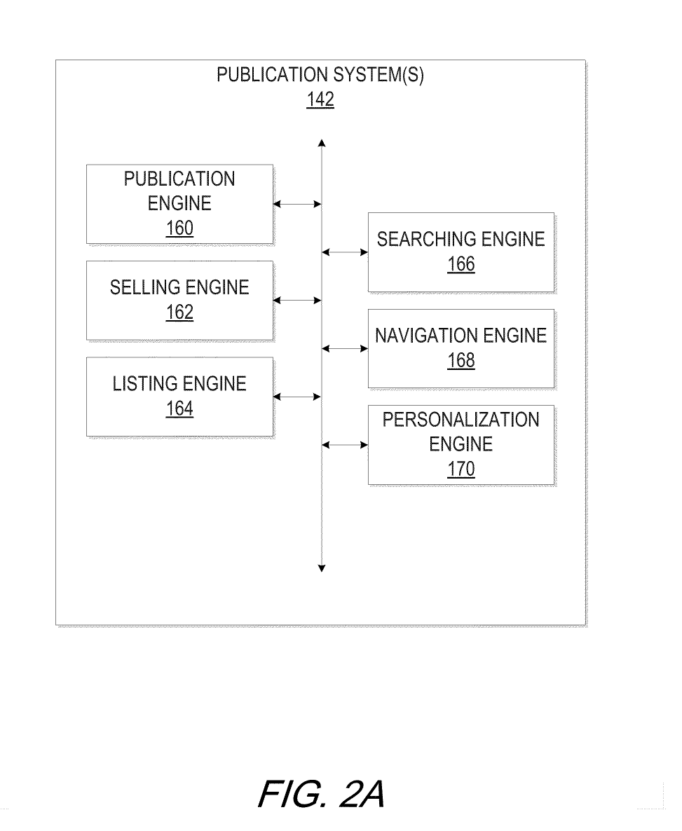

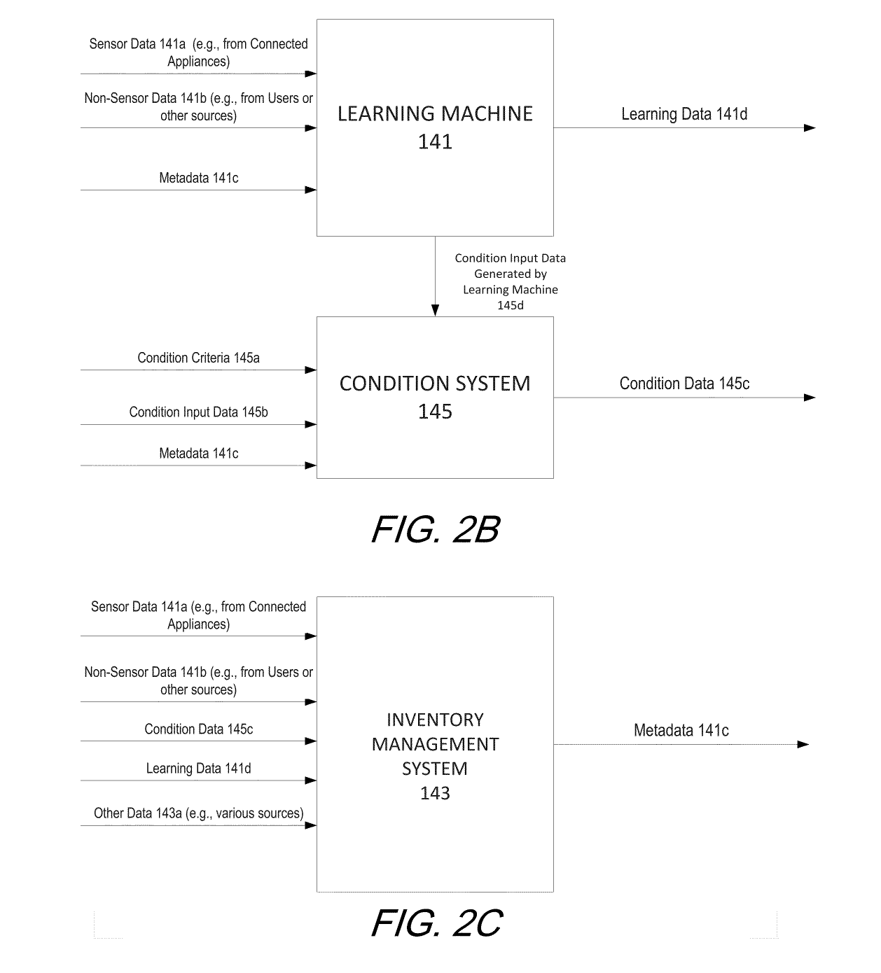

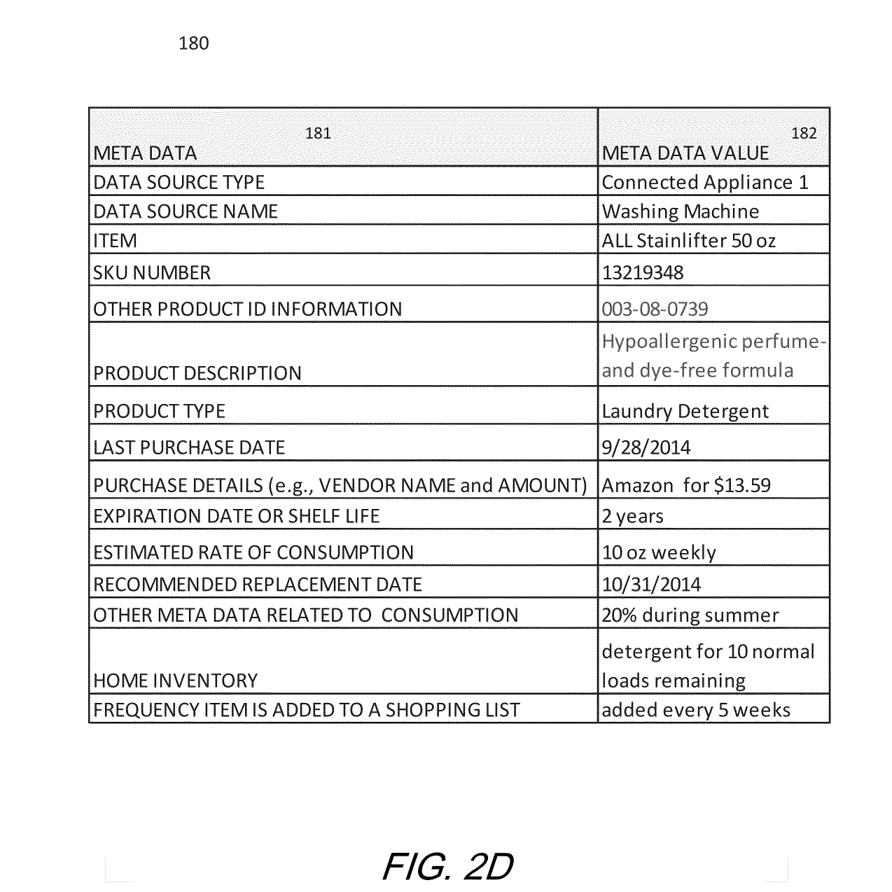

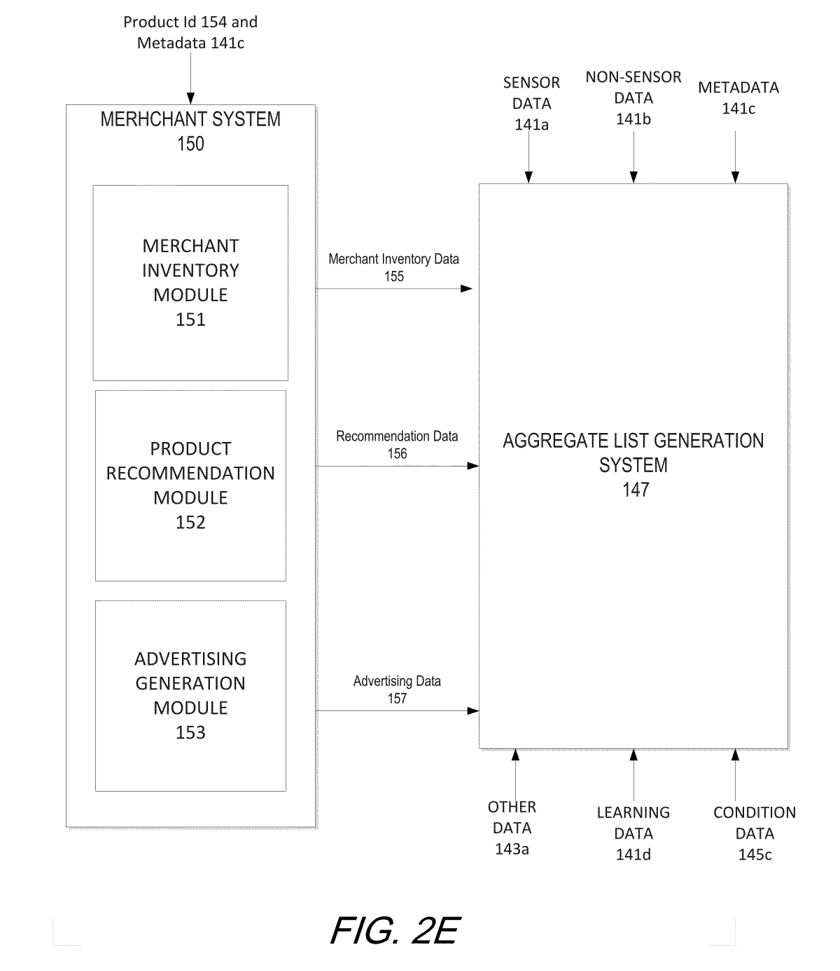

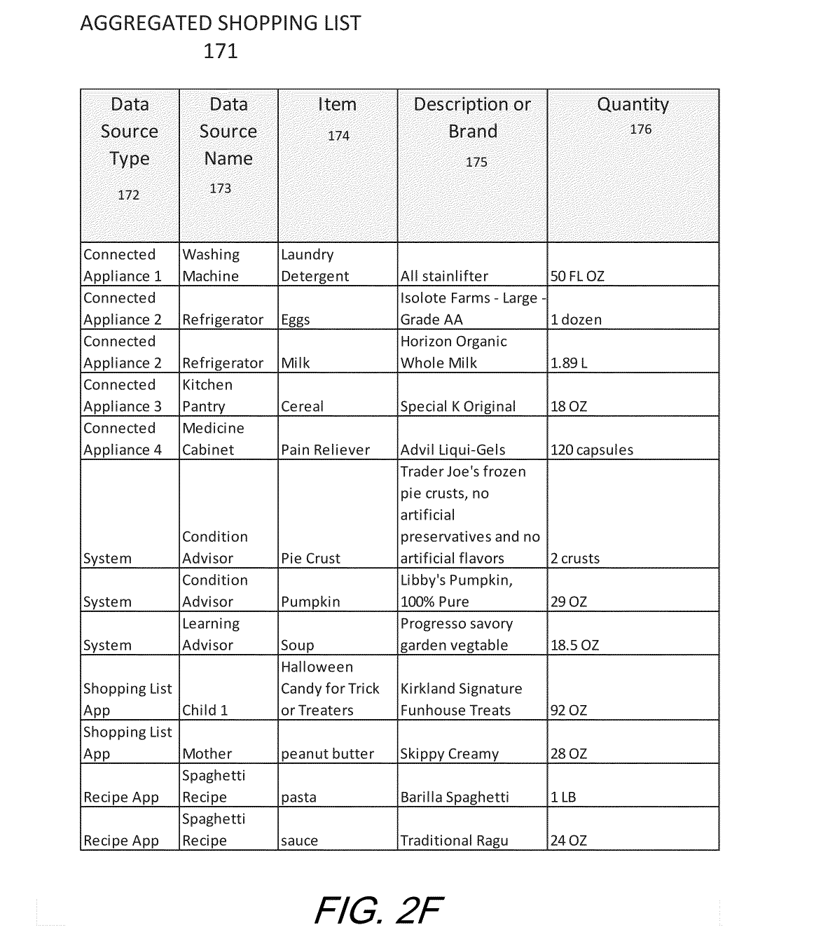

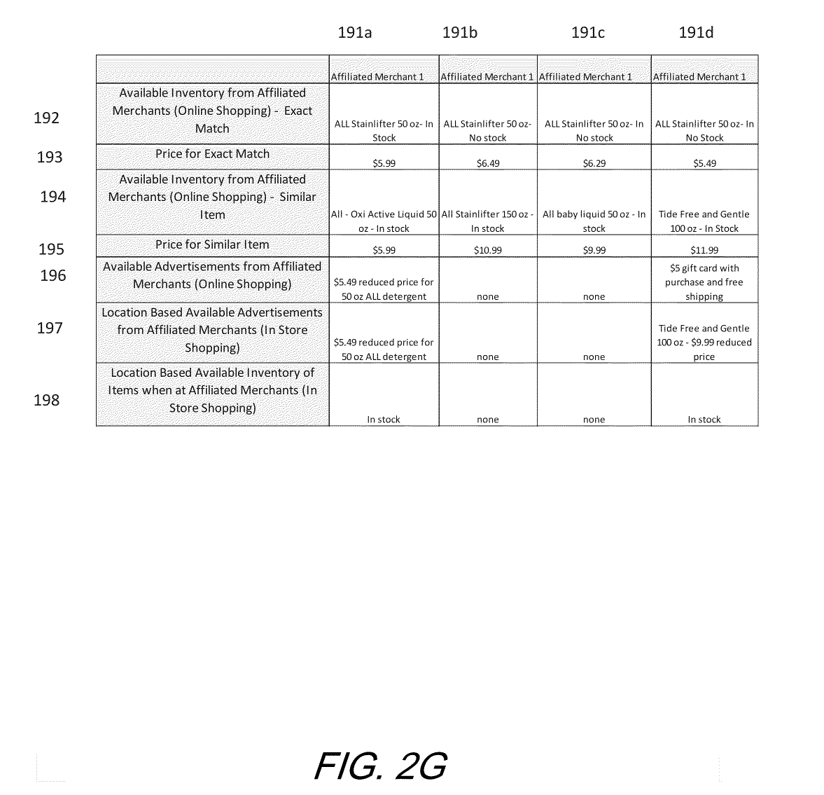

A dynamic list system 146 includes a learning machine 141 for generating learning data, a condition system 145 for generating condition data, and an inventory management system 143 for collecting, generating, tracking, and storing metadata for the product inventory within the home environment 129. The connected appliances 131 may also use their sensors to relay information to the inventory management system 143 and the learning machine 141 for generating the aggregate shopping list. The aggregate list generation system 147 within the dynamic list system 146 receives learning data from the learning machine 141, condition data from the condition system 145, metadata from the inventory management system 143, and merchant product data (including product inventory data) and other data from a merchant inventory system 150 to generate the aggregate shopping list. An example of an aggregate shopping list which includes data from multiple data source types that provide the sensor data, non-sensor data, or system generated data (e.g., learning data or condition data) is shown in FIG. 2F. For the embodiment shown in FIG. 1A, sensor and non-sensor data 127a may be stored in a database 126a, learning and condition data 127b may be stored in a database 126b, metadata 127c may be stored in the database 126c, merchant product data 127d may be stored in a database 126d, and other data 127e may be stored in a database 126e.

With reference to FIG. 1B, an example embodiment of a high-level client-server-based network architecture 105 is shown. The networked system 102 provides server-side functionality via a network 104 (e.g., the Internet or wide area network (WAN)) to a client device 110. A user (e.g., user 106) may interact with the networked system 102 using the client device 110. FIG. 1B illustrates, for example, a web client 112 (e.g., a browser, such as the Internet Explorer® browser developed by Microsoft® Corporation of Redmond, Wash. State), client application(s) 114, and a programmatic client 116 executing on the client device 110. The client device 110 may include the web client 112, the client application(s) 114, and the programmatic client 116 alone, together, or in any suitable combination. Although FIG. 1B shows one client device 110, multiple client devices may be included in the network architecture 100.

The client device 110 may comprise a computing device that includes at least a display and communication capabilities that provide access to the networked system 102 via the network 104. The client device 110 may comprise, but is not limited to, a remote device, work station, computer, general purpose computer, Internet appliance, hand-held device, wireless device, portable device, wearable computer, cellular or mobile phone, personal digital assistant (PDA), smart phone, tablet, ultrabook, netbook, laptop, desktop, multi-processor system, microprocessor-based or programmable consumer electronic, game consoles, set-top box, network personal computer (PC), mini-computer, and the like. In further example embodiments, the client device 110 may comprise one or more of a touch screen, accelerometer, gyroscope, biometric sensor, camera, microphone, global positioning system (GPS) device, and the like. In some embodiments, the client device 110 may be integrated into one of the connected appliances 131.

The client device 110 may communicate with the network 104 via a wired or wireless connection. For example, one or more portions of the network 104 may be an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or a combination of two or more such networks.

The client device 110 may include one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and so on. The client application(s) 114 may include various components operable to present information to the user and communicate with networked system 102. In some embodiments, if the e-commerce site application is included in the client device 110, then this application may be configured to locally provide the UI and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 may use its web browser to access the e-commerce site (or a variant thereof) hosted on the networked system 102.

In various example embodiments, the users (e.g., the user 106) may be a person, a machine, or other means of interacting with the client device 110. In some example embodiments, the users may not be part of the network architecture 100, but may interact with the network architecture 100 via the client device 110 or another means. For instance, the users may interact with a client device 110 that may be operable to receive input information from (e.g., using touch screen input or alphanumeric input) and present information to (e.g., using graphical presentation on a device display) the users. In this instance, the users may, for example, provide input information to the client device 110 that may be communicated to the networked system 102 via the network 104. The networked system 102 may, in response to the received input information, communicate information to the client device 110 via the network 104 to be presented to the users. In this way, the user may interact with the networked system 102 using the client device 110.

An Application Program Interface (API) server 120 and a web server 122 may be coupled to, and provide programmatic and web interfaces respectively to, one or more application server(s) 140. The application server(s) 140 may host one or more publication system(s) 142, payment system(s) 144, and a dynamic list system 146, each of which may comprise one or more modules or applications and each of which may be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 may also store digital goods information, in accordance with some example embodiments. In an example embodiment, the database(s) 126 include databases 126a-126e.

Additionally, a third party application 132, executing on a third party server 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

The publication system(s) 142 may provide a number of publication functions and services to the users that access the networked system 102. The payment system(s) 144 may likewise provide a number of functions to perform or facilitate payments and transactions. While the publication system(s) 142 and payment system(s) 144 are shown in FIG. 1B to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

The dynamic list system 146 may provide functionality to generate an aggregate shopping list based on multiple types of data and multiple data source types. For example, non-sensor data from applications stored in a cloud computing environment or within the networked system 102 may provide items to be added to the aggregate shopping list. An example of an application is the Evernote app, which is a multi-functional app that may be used to create notes or lists used as a shopping list. Additionally, sensor data from connected appliances 131 within an environment may detect changes in an environment and provide items to be added to the aggregate shopping list. Furthermore, system generated data (e.g., from a learning machine 141 or a condition system 145) may provide items to be added to the aggregate shopping list. The metadata collected, generated, tracked, and stored in the inventory management system 143 and the aggregate list generation system 147 are used to create the aggregate shopping list. In one embodiment, the inventory management system 143 may be integrated with the aggregate list generation system 147. In some example embodiments, the dynamic list system 146 may communicate with the client device 110, the third party server(s) 130, the publication system(s) 142 (e.g., retrieving inventory and product information), and the payment system(s) 144 (e.g., purchasing a shopping list items). In an alternative example embodiment, the dynamic list system 146 may be a part of the publication system(s) 142. In some embodiments, the merchant inventory system 150 may be included within the publication system(s) 142 or the dynamic list system 146.

Further, while the client-server-based network architecture 100 shown in FIG. 1B employs a client-server architecture, the present inventive subject matter is, of course, not limited to such an architecture, and may equally well find application in a distributed, or peer-to-peer, architecture system, for example. The various systems of the applications server(s) 140 (e.g., the publication system(s) 142 and the payment system(s) 144) may also be implemented as standalone software programs, which do not necessarily have networking capabilities.

The web client 112 may access the various systems of the networked system 102 (e.g., the publication system(s) 142) via the web interface supported by the web server 122. Similarly, the programmatic client 116 and client application(s) 114 may access the various services and functions provided by the networked system 102 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

FIG. 2A illustrates a block diagram showing components provided within the publication system(s) 142, according to some embodiments. In various example embodiments, the publication system(s) 142 may comprise a marketplace system to provide marketplace functionality (e.g., facilitating the purchase of items associated with item listings on an e-commerce website or on an aggregate shopping list). The networked system 102 may be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more database(s) 126 via the database server(s) 124.

The networked system 102 may provide a number of publishing, listing, and price-setting mechanisms whereby a seller or merchant may list (or publish information concerning) goods or services for sale or barter, a buyer can express interest in or indicate a desire to purchase or barter such goods or services, and a transaction (such as a trade) may be completed pertaining to the goods or services. To this end, the networked system 102 may comprise a publication engine 160 and a selling engine 162. The publication engine 160 may publish information, such as item listings or product description pages, on the networked system 102. The selling engine 162 may further comprise one or more deal engines that support merchant-generated offers for products and services.

A listing engine 164 allows sellers to conveniently author listings of items or authors to author publications. In one embodiment, the listings pertain to goods or services that a merchant may wish to transact via the networked system 102. In some embodiments, the listings may be an offer, deal, coupon, or discount for the good or service. Each good or service is associated with a particular category. The listing engine 164 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., database(s) 126). Listings also may comprise product description pages that display a product and information (e.g., product title, specifications, and reviews) associated with the product. In some embodiments, the product description page may include an aggregation of item listings that correspond to the product described on the product description page. In some embodiments, the listing engine 164 permits sellers to generate offers from a seller's mobile devices. The generated offers may be uploaded to the networked system 102 for storage and tracking.

Searching the networked system 102 is facilitated by a searching engine 166. For example, the searching engine 166 enables keyword queries of listings published via the networked system 102. In example embodiments, the searching engine 166 receives the keyword queries from a device of a user and conducts a review of the storage device storing the listing information. The review will enable compilation of a resulting set of listings that may be sorted and returned to the client device 110 of the user. The searching engine 166 may record the query (e.g., keywords) and any subsequent user actions and behaviors (e.g., navigations, selections, or click-throughs).

The searching engine 166 also may perform a search based on a location of the user. A user may access the searching engine 166 via a mobile device and generate a search query. Using the search query and the user's location, the searching engine 166 may return relevant search results for products, services, offers, auctions, and so forth to the user. The searching engine 166 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

In a further example, a navigation engine 168 allows users to navigate through various categories, catalogs, or inventory data structures according to which listings may be classified within the networked system 102. For example, the navigation engine 168 allows a user to successively navigate down a category tree comprising a hierarchy of categories (e.g., the category tree structure) until a particular set of listings is reached. Various other navigation applications within the navigation engine 168 may be provided to supplement the searching and browsing applications. The navigation engine 168 may record the various user actions (e.g., clicks) performed by the user in order to navigate down the category tree.

In some example embodiments, a personalization engine 170 may allow the users of the networked system 102 to personalize various aspects of their interactions with the networked system 102. For instance, the users may define, provide, or otherwise communicate personalization settings that the personalization engine 170 may use to determine interactions with the networked system 102. In further example embodiments, the personalization engine 170 may automatically determine personalization settings and personalize interactions based on the automatically determined settings. For example, the personalization engine 170 may determine a native language of the user and automatically present information in the native language.

FIG. 2B illustrates input data and output data for a learning machine and condition system, according to an example embodiment. FIG. 2C illustrates input and output data for an inventory management system, according to an example embodiment. As shown in FIG. 1A, the learning machine 141, the condition system 145, and the inventory management system 143 are components within the dynamic list system 146. As shown in FIG. 2B, sensor data 141a, non-sensor data 141b, and metadata 141c are provided as inputs into the learning machine 141. The learning machine 141 generates learning data 141d.

The learning data 141d represents data inferred based on predictive modeling as to when a product may need to be ordered. For example, if milk appears on the aggregate shopping list with a certain frequency, then predictive modeling is used to add milk to the aggregate shopping list at the same frequency (e.g., every 5 days). The frequency at which milk appears on the aggregate shopping list may be collected and stored by the inventory management system 143 as metadata 141c. Additionally, refrigerator sensors may also observe the rate of decrease of the user's inventory of milk, and provide the learning machine 141 with sensor data indicating that only a third of the milk is left in the milk carton such that the learning machine 141 can estimate the remaining time until milk needs to be added to the shopping list and ordered. Additionally, the learning machine 141 may receive non-sensor data representing a user-designated item to be added to a shopping list app on the client device 110a. In this example, the user added one gallon of whole organic milk to be added to the list maintained by the shopping list app. The learning machine 141 receives this non-sensor data 141b and determines that the sensor data 141a and the non-sensor data 141b indicate duplicate shopping items such that only one gallon of whole organic milk is added to the aggregate shopping list, rather than two gallons of organic whole milk. The sensor data 141a and the non-sensor data 141b typically include product identification information sufficient to identify the product to order. For example, the sensor on a connected appliance 131 may include a camera that captures the stock keeping unit (SKU) number of the product to be ordered, and provides the product identification information as part of the sensor data 141a. The product identification number may be used to match the shopping list item with inventory available from merchants within a network of affiliated merchants. The matches may be exact matches, similar matches, or generic matches.

The condition system 145 receives condition criteria 145a, condition input data 145b, and metadata 141c as input. The condition system 145 also receives condition input data generated by the learning machine 145d. The condition system 145 generates condition data 145c. In some embodiments, the condition system 145 overrides learning data 141d generated by the learning machine 141. For example, one condition criteria is during the summer when the temperature is above 90° F., order twice as much bottled water and soda as specified by the learning data 141d. Condition criteria 145a may be related to the time of the year (e.g., calendar seasons, football season, holidays, or school year), weather, or travel plans (e.g., preparing for a camping trip or out of town), in example embodiments.

The inventory management system 143 collects, generates, and tracks metadata for items in a home or other environments to help manage the inventory. The inventory management system 143 collects sensor data 141a, non-sensor data 141b, condition data 145c, learning data 141d, and other data 143a from various sources. The metadata is stored in one or more tables in at least one database, for example database 126c. On example of metadata fields tracked by the inventory management system 143 is shown in FIG. 2D. The table 180 shown in FIG. 2D includes a metadata name field 181 and a meta data value field 182. Various other metadata fields, not shown in FIG. 2D, may be collected, tracked, and stored by the inventory management system 143.

FIG. 2E illustrates an aggregate list generation system receiving multiple data types from multiple data source types, according to an example embodiment. The aggregate list generation system 147 combines multiple data types received from multiple data sources into an aggregate shopping list for presentation to the user 106 via a client device 110. The aggregate shopping list presented to the user 106 may display the data source type and the data source to help the user in making decisions whether the items should be ordered, for example online with or without delivery service, or whether to pick up the items from the physical stores having inventory.

An example of data fields that may be included in a UI displaying an aggregate shopping list is shown in FIG. 2F. The aggregate shopping list 171 shown in FIG. 2F includes the following fields: data source type 172, data source name 173, item 174, description or brand 175, and quantity 176. Other examples of an aggregate shopping list may include additional fields, modified fields, or deleted fields as compared to the aggregate shopping list 171. The aggregate shopping list includes items added by users 106a and 106b, connected appliances 131, and by a system, such as the dynamic list system 146 or components within the dynamic list system 146. Referring to FIG. 2F, the data source type 172 represents a field designating the source of the data. The data source types 172 specified as the connected appliance 1, the connected appliance 2, the connected appliance 3, and the connected appliance 4 indicate that the connected appliances 131 are the data source type and sensor data is provided to the dynamic list system 146. The data source type 172 specified as system indicates that the data source type is from the learning machine 141 or the condition system 145 and represents system generated data. The data generated by the learning machine 141 is referred to as learning data (e.g., learning data 141d) and the data generated by the condition system 145 is referred as condition data (e.g., condition data 145c). The data source types 172 specified as the shopping list app and the recipe app indicate that the data source type is from an app used by the user 106. For example, the user adds items to be ordered or purchased from a shopping list app, or the user selects a recipe and the inventory management system 143 determines which items need to be ordered based on the inventory in the environment (e.g., home environment).

The aggregate list generation system 147 generates the aggregate shopping based on various data types received from the various data source types. The data received by the aggregate list generation system 147 include sensor data 141a, non-sensor data 141b, metadata 141c, other data 143a, learning data 141d and condition data 145c. Referring back to FIG. 2E, the merchant system 150, in an example embodiment, includes a merchant inventory module 151, a product recommendation module 152, and an advertising generation module 153. The merchant inventory module 151 provides merchant inventory data 155 to the aggregate list generation system 147. The product recommendation module 152 provides recommendation data 156 to the aggregate list generation system, and the advertising generation module 153 provides advertising data 157 to the aggregate list generation system 147. The merchant system 150 receives product ID 154, which may be provided by the connected appliances 131 and included with the sensor data 141a in some embodiments. In other embodiments, product ID 154 may be provided by other sources, such as the user. The product ID 154 may represent the SKU for the items to be added to the aggregate list generation system 147. The SKU may be different for the various merchants and may require some processing to match or pair the SKU received with products available from the various merchants. Once the product to be added to the aggregate shopping list is identified, either by exact match, similar match, or generic match, the merchant system 150 may identify inventory available from the merchants associated with the merchant system 150, and recommend products and offer advertisements. The merchant system 150 may be associated with a network of affiliated merchants, such that merchant system 150 has access to products offered by the affiliated merchants, inventory of the products at the affiliated merchants, and advertising offers available from the affiliated merchants. For example, many companies offering e-commerce applications, such as eBay, Amazon, and Google, each have a network of affiliated merchants which may sell items on their e-commerce website.

Once the aggregate shopping list is presented to the user 106, the user 106 may provide additional input to select products recommended to the user. The user 106 may also receive advertisements for discounts on the items recommended. The user 106 may access the aggregate shopping list from a client device 110 using an app or web browser, which may be the same app as the shopping list apps 132 and 133, or a different app such as an aggregate shopping list app. The aggregate shopping list app may be accessible from one of the connected appliances 131, such as refrigerator. FIG. 2G illustrates some additional fields that may be displayed to the user 106 to help the user 106 select recommended products from a number of merchants. The affiliated merchants 1-4 are shown by 191a-191d, respectively. The fields 192-198 represent information that may be provided to the user 106 along with the aggregate shopping list. Fields 192 and 193 relate to inventory and price for exact matches. The fields 194 and 195 represent inventory and price for similar items. The field 196 represents advertisements offered by the affiliated merchants 191a-191d. Fields 197 and 198 relate to in store shopping and provide location based information related to ads and inventory while the user 106 is shopping at one of the affiliated merchants 191a-191d.

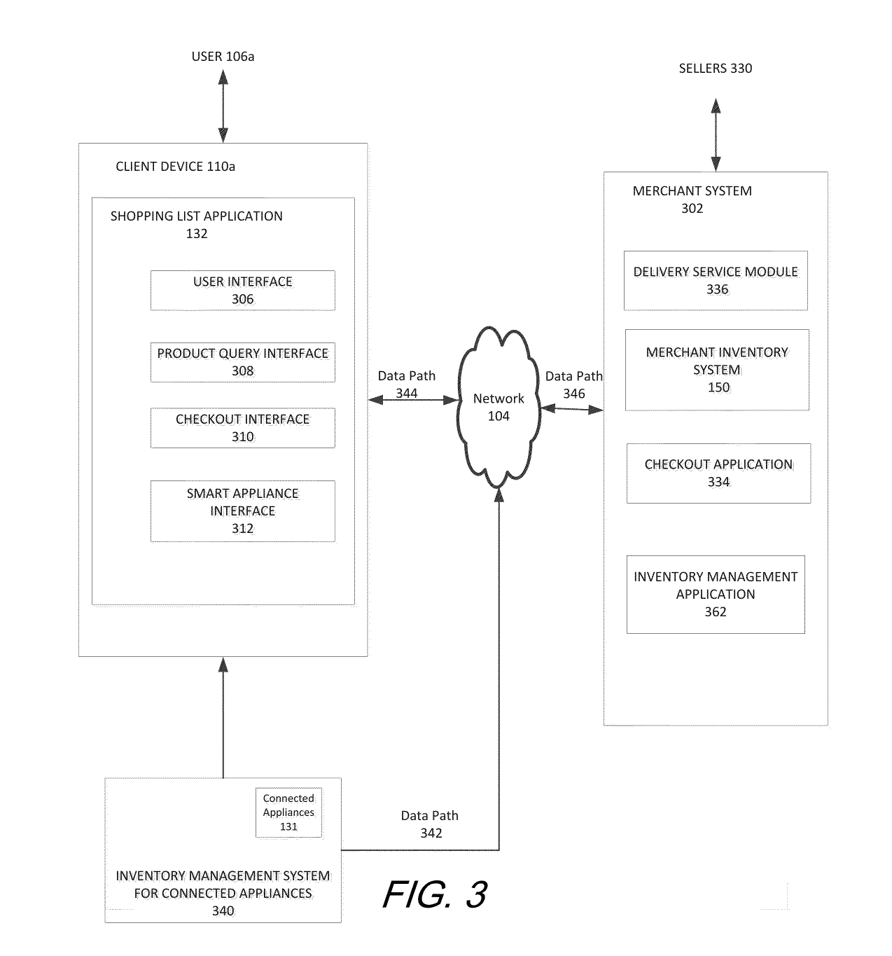

FIG. 3 illustrates a system for a client device running a shopping list application to facilitate purchase transactions with a merchant system, according to an example embodiment. In some embodiments, the merchant system 302 may be included within the publication system(s) 142. The sellers 330 may represent a network of affiliated merchants. A merchant system 302 may include a delivery service module 336, a merchant inventory system 150, a checkout application 334, and an inventory management application 362. The user 106a uses a client device 110a to run a shopping list application 132 to conduct transactions with one or more sellers 330 using a merchant system 302. The shopping list application 132 enables user 106a to create, view, organize, and manage a shopping list with information updates from the sellers 330. For example, the user 106a may use the shopping list application 132 to create a shopping list of items to purchase and to obtain detailed information of items on the shopping list from the sellers 330. The detailed information enables user 106a to compare products from the sellers 330 to help the user 106a select specific products to purchase and the specific seller from which to make the purchase. The user 106a may also use the shopping list application 132 to automatically check off items that have been purchased and to be reminded about items that have yet to be purchased during checkout.

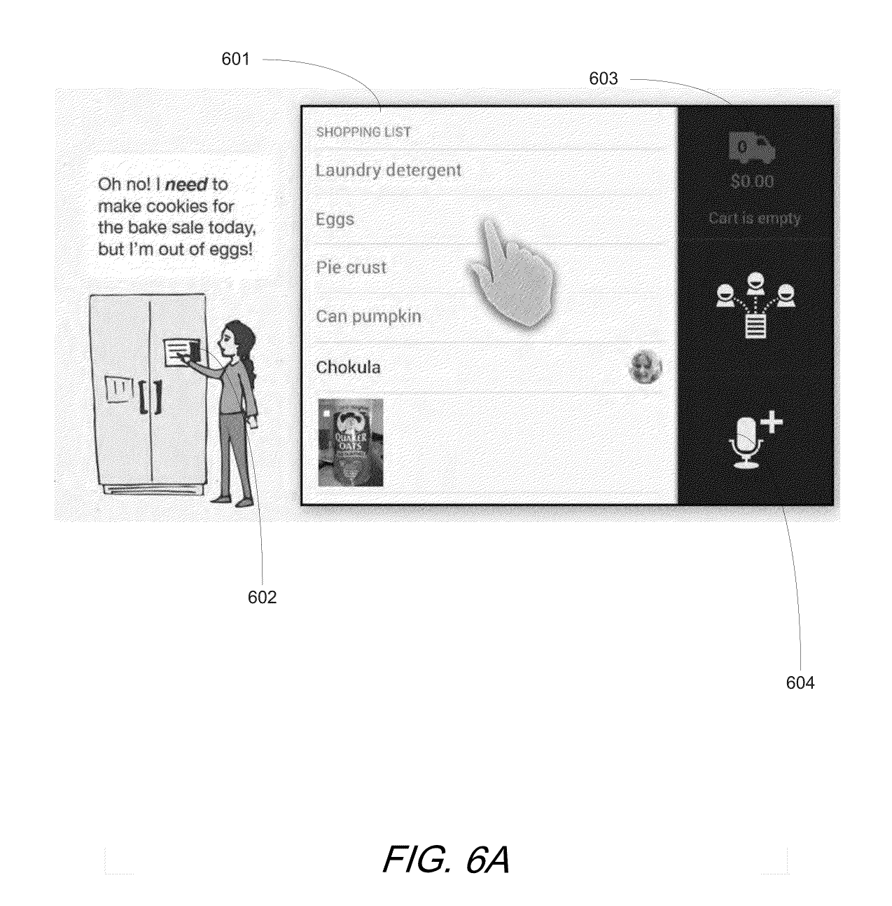

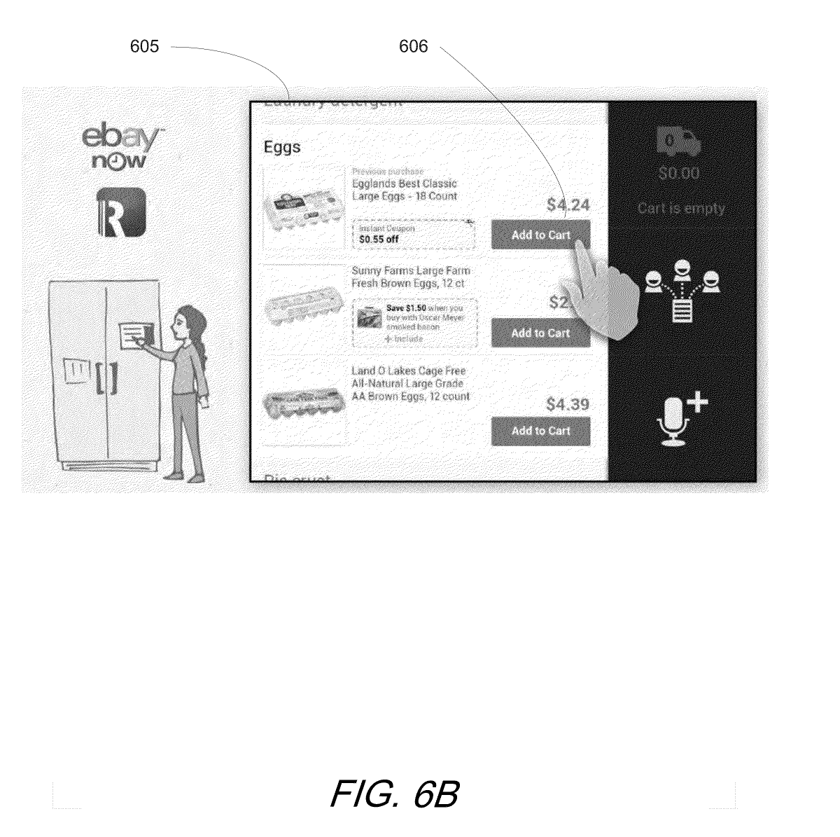

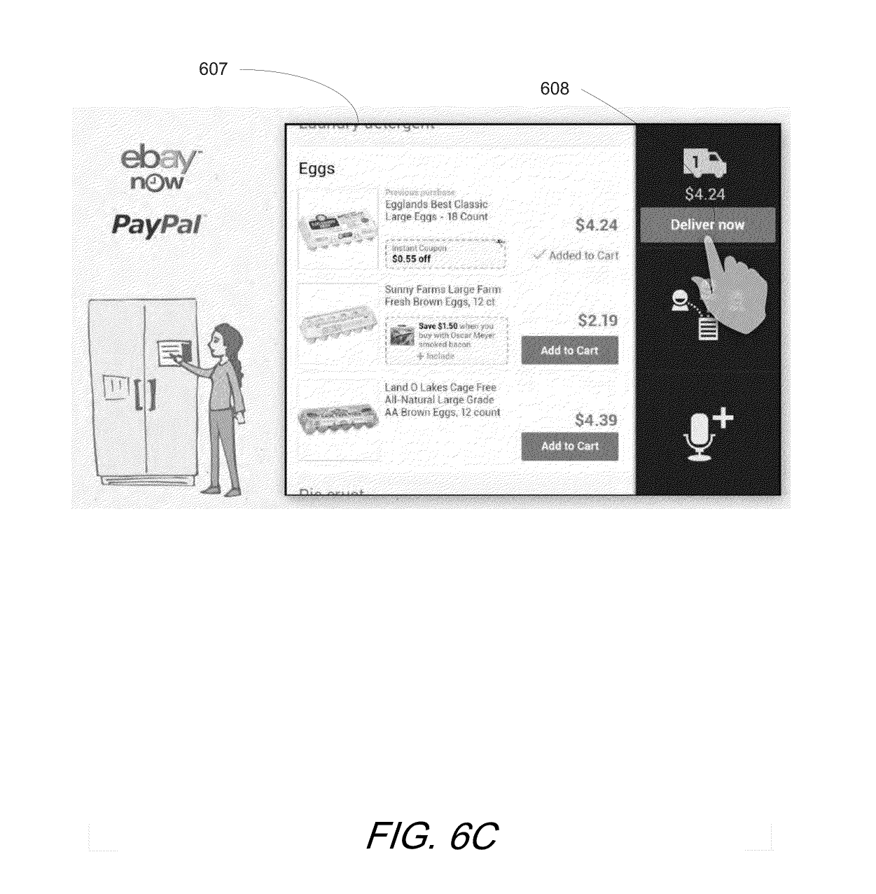

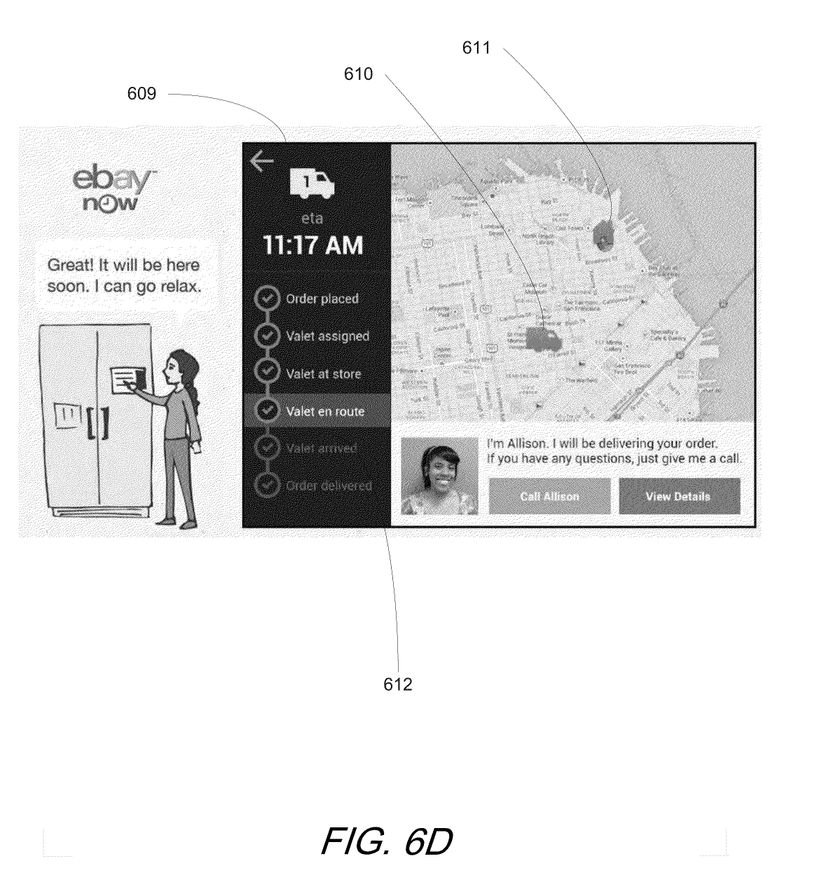

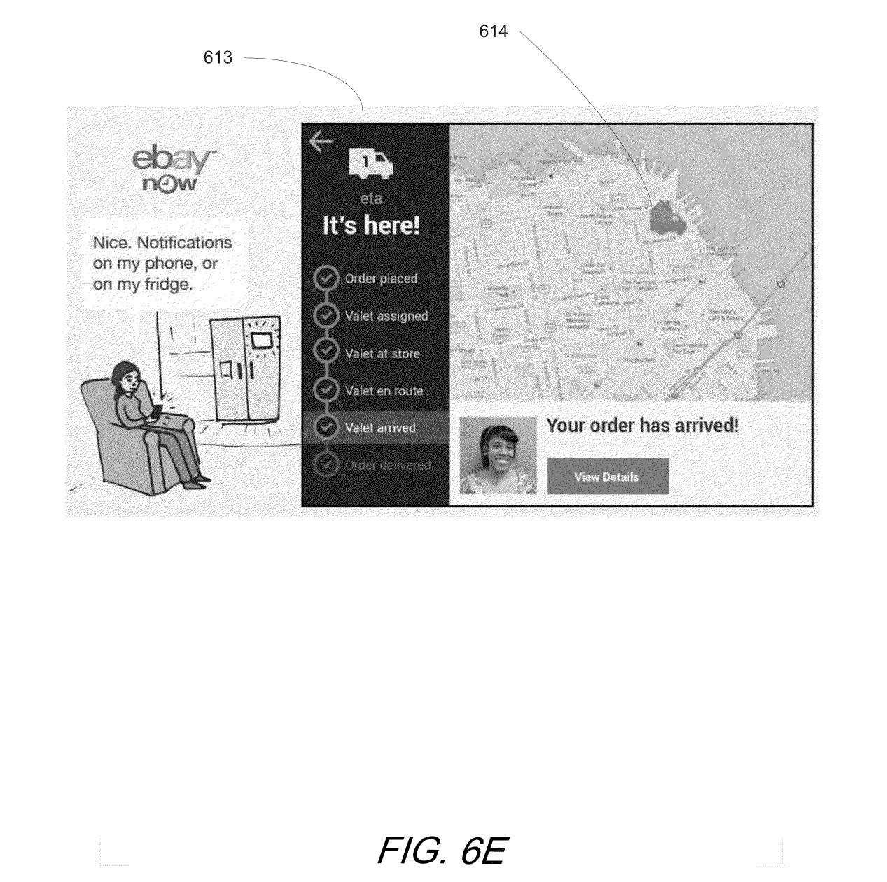

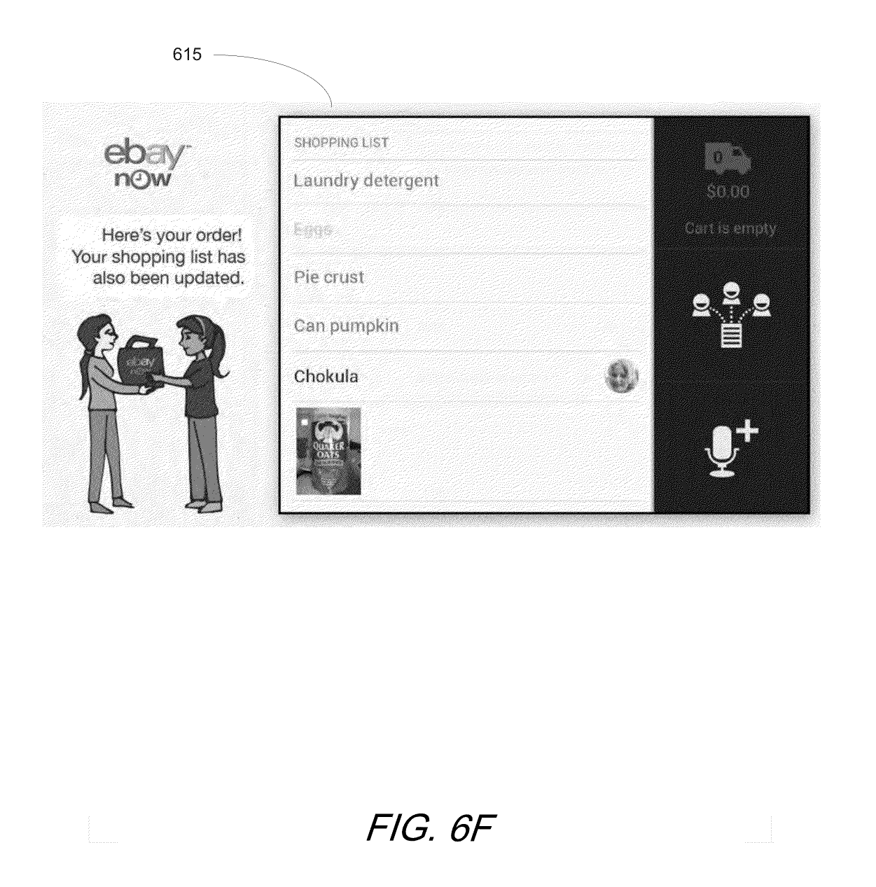

The client device 110a that runs the shopping list application 132 may be a smart phone (e.g., iPhone, Google phone, or other phones running Android, Window Mobile, or other operating systems), a tablet computer (e.g., iPad, Galaxy), PDA, a notebook computer, or various other types of wireless or wired computing devices. In some embodiments, the client device 110a may be partially or fully integrated with a connected appliance 131. For example, a refrigerator may include a display with a UI as shown in FIG. 6A. The client device 110a may communicate from a network 104 with the merchant system 302.

The shopping list application 132 includes a UI 306, a product query interface 308, a checkout interface 310, and a smart appliance interface 312. The shopping list application 132 may receive input from one or more connected appliances 131 located within the inventory management system for connected appliances 340.

For an example embodiment, the inventory management system for connected appliances 340 manages the grocery and household inventory within a home environment (or other environment) so products and items can be purchased when the inventory is low. The connected appliances 131 may dynamically detect products that a user may need to purchase based on detecting or sensing changes in the environment. Examples of connected appliances include a refrigerator that uses a scale and image recognition to automatically detect out-of-stock items such as milk and eggs, a printer that can automatically detect that it is running low on ink cartridges, and a pantry that uses image recognition to order out-of-stock items. In alternative embodiments, groceries and other household items may be ordered automatically based on historical consumption patterns. The inventory management system for connected appliances 340 provides updates to the shopping list application 132. The updates may incorporate sensor data from various sensors. Based on updates provided by the inventory management system for connected appliances 340 and additional input from the user, the shopping list application 132 may present various product recommendations to the user for purchase.

Sensor data from the smart appliances may be transmitted to the network over path 342 and then to the merchant system 302 over data path 346. Alternatively, the sensor data may be sent over data path 344 to the network 104 and then over data path 346 to the merchant system 302. Furthermore, non-sensor data from the shopping list application 132 may be provided to the network 104 over data path 344 and then to the merchant system 302 over data path 346. In some embodiments, the non-sensor data from the shopping list application may be stored in a cloud computing environment (not shown) connected to the network 104, and accessible by the merchant system 302.

The UI 306 allows user 106a to interact with shopping list application 132 and to conduct transactions with the sellers 330 using the merchant system 302 over the network 104. For example, the UI 306 allows the user 106a to input the shopping list of items to purchase, and to view and manage the items and detailed information of the items on the shopping list. The inputting of items to purchase may be done in any number of ways. In one example, the user manually types in individual items or product types using a keypad or keyboard. In another example, the user may select items or product types from a list, such as a drop down menu of items/types available for purchase from a seller or items/types previously purchased by the user. If the user 106a is planning on going to a specific store, the shopping list may include only those items or types available at that store. Creating an aggregate shopping list may include a combination of manual entry with user-specified input data (also referred to as non-sensor data), sensor data, and system generated data, along with product/type selection. In one embodiment, the UI 306 includes a software program, such as a UI, executable by a processor and configured to interface with user 106a. User 106a may also use the GUI to access and browse product information of products that match one of the items on the shopping list where the products are available for purchase from the sellers 330.

The product query interface 308 enables shopping list application 132 to obtain product information for items on the shopping list from sellers 330 over network 104. The product information of products in sellers' 330 inventories is stored in a merchant inventory system 150, also referred to as a seller inventory database. The merchant inventory system 150 may match the queried items against products in its database, check for the availability of the products, and provide product information to product query interface 308. The user 106a may also receive product recommendations through product query interface 308. Alternatively in other embodiments, user 106a may want to download product information from sellers 330 over network 104. For example, product query interface 308 may query for product information of products matching items on the shopping list over the Internet from one or more sellers 330 that user 106a has designated. In addition, product query interface 308 may query merchant inventory system 150 to provide preferential pricing if user 106a belongs to a loyalty program of one of the sellers 330.

The product information of products matching items on the shopping list from the merchant inventory system 150 may include brands, descriptions, pricing information, and so forth of the products. If the item on the shopping list is a general product category, the product information may include information on a selection of products that belong to the general product category. The merchant inventory system 150 may also provide information on discounts, promotions, specials, and the like on products matching items on the shopping list or may provide product information of products related to items on the shopping list. The user 106a may view and compare product information from one or more sellers 330 through UI 306. Based on the product information and recommendations presented to the user, including deals, pricing and delivery options, user 106a may select the specific products to purchase from a seller and/or may purchase items on the shopping list from multiple sellers to get the best price, selection, and delivery options.

Once user 106a has selected the products to purchase and is ready to checkout, checkout interface 310 of shopping list application 132 may help shopping list application 132 keep track of items from the shopping list that have been purchased and may alert user 106a of any items remaining on the shopping list. For example, checkout interface 310 may communicate with a checkout application 334 from the sellers 330 over network 104 to obtain information on purchased products. Checkout interface 310 may query checkout application 334 of the sellers 330 for information on the sales receipt to obtain information on the purchased products. The checkout interface 310 may check items on the shopping list against the purchased products on the sales receipt to identify items that have been purchased and items that remain to be purchased. Before the completion of checkout, if the shopping list contains any un-purchased items with one or more matching products that are available from the seller, UI 306 may alert user 106a to the un-purchased item.

The delivery service module 336 is responsible for providing delivery updates to the user 106a. For example, the user 106a will be notified as to the valet assigned to the order, when the valet is at the store picking up the ordered items, when the valet is en route to deliver the items, when the valet has arrived at the purchaser's location, and when the order has been delivered.

The inventory management application 362 may provide data to other systems or applications (e.g., the publications system 140 or the payment systems 144). In some embodiments, the inventory management application 362 may be integrated into the publications system 142 or the dynamic list system 146.

The inventory management application 362 may store data about items (e.g., groceries, household products, books, cars, guitars, and other tangible or intangible goods). For example, the database may have tables storing information regarding wood, paper, food, and electronic subscriptions. These tables may indicate not only static information about the items such as a name and an image, but also dynamic information such as a current inventory and a rate of use. The inventory management application 362 may also store data about users. The inventory management application 362 may also have tables indicating which of these items is owned by a particular user. For example, in a home, multiple users of the inventory management application 362 may each have ownership of different items. To illustrate, one roommate may consume one brand of soda (e.g., Brand X) while another roommate consumes a different brand of soda (e.g., Brand Y). An image sensor (e.g., a camera) in the refrigerator, coupled to a processor configured to analyze images and identify the number of cans of each type of soda, may determine when the quantity of Brand X or Brand Y soda falls below a predetermined threshold. Based on an association of the soda with the corresponding roommate, an order for the soda may be placed and the appropriate roommate billed.

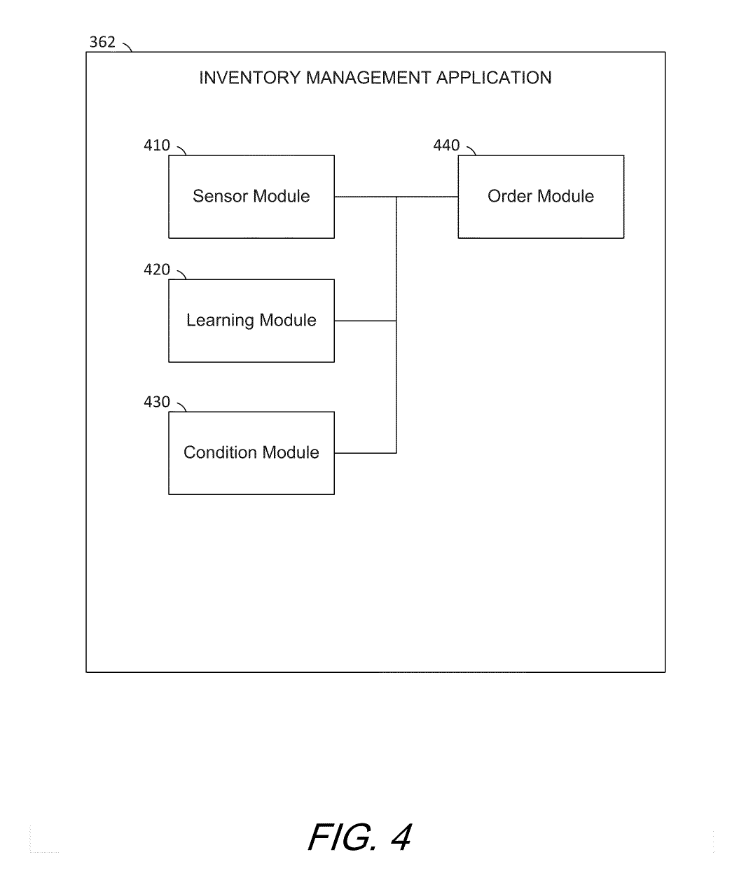

FIG. 4 is a block diagram illustrating components of the inventory management application, according to some example embodiments. The inventory management application 362 is shown as including a sensor module 410, a learning module 420, a condition module 430, and an order module 440, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. In some embodiments, one or components of the inventory management application 362 may be incorporated into the inventory management system for connected appliances 340 or the merchant system 302 (as shown in FIG. 3).

The sensor module 410 may be configured to receive sensor data. For example, a temperature may be received from a thermometer, a weight may be received from a scale, or an image may be received from a camera. The sensor module 410 may process the sensor data to determine a quantity of an item in the user's inventory. For example, an image may be processed to count individual depicted items or to estimate a volume occupied by the item. To illustrate, a number of cans of soda may be counted or the size of a stack of paper estimated from the image and used to calculate a number of pages of paper in the inventory.

The learning module 420 may be configured to learn the usage patterns of the users 106a and 106b. For example, data from the sensor module 410 may be periodically fed to the learning module 420. By observing the rate of decrease of the user's inventory of an item, an estimated remaining time until depletion can be calculated. More complex usage patterns may also be learned. For example, the rate of decrease of the user's inventory may vary depending on the temperature or the season, and this variance may be taken into account when estimating the remaining time until depletion.

The condition module 430 may be configured to access and store conditions for triggering the ordering of an item. Conditions (also referred to as a condition criteria) stored by the condition module 430 may be received through a GUI (e.g., from client devices 110a or 110b) or from the learning module 420. In one example embodiment, the user enters the precise conditions to be met for items to be added to a shopping list or to trigger an order for the items. This may be done through the use of GUI components such as text fields, drop-down menus, date selectors, and the like. In another example embodiment, no conditions are entered by the user. Instead, sensors monitor the quantity of various items and the inventory management application 362 monitors orders placed by the user for the various items. The learning module 420 correlates the orders with sensor data and automatically generates conditions for the condition module 430. In another example embodiment, a mix of these two approaches is used.

The order module 440 may be configured to determine when conditions stored by the condition module 430 are met and to add an item to a shopping list or place an order for the corresponding items. For example, the condition module 430 may access a condition indicating that when the number of eggs in the refrigerator falls below 3, a dozen eggs should be added to the shopping list and ordered. The order module 440 may receive data from the sensor module 410 indicating that 2 eggs are present in the user's inventory and conclude that the condition accessed by the condition module 430 has been met. In response, the order module 440 may communicate with the e-commerce application (e.g., from the publication system 142) to place an order. For example, the order module 440 may send the user's address and credit card information along with the quantity of the item to be ordered. The publications system(s) 142 may cause the user's account to be charged for the ordered items and communicate the order to the appropriate parties (e.g., the warehouse storing the physical items ordered).

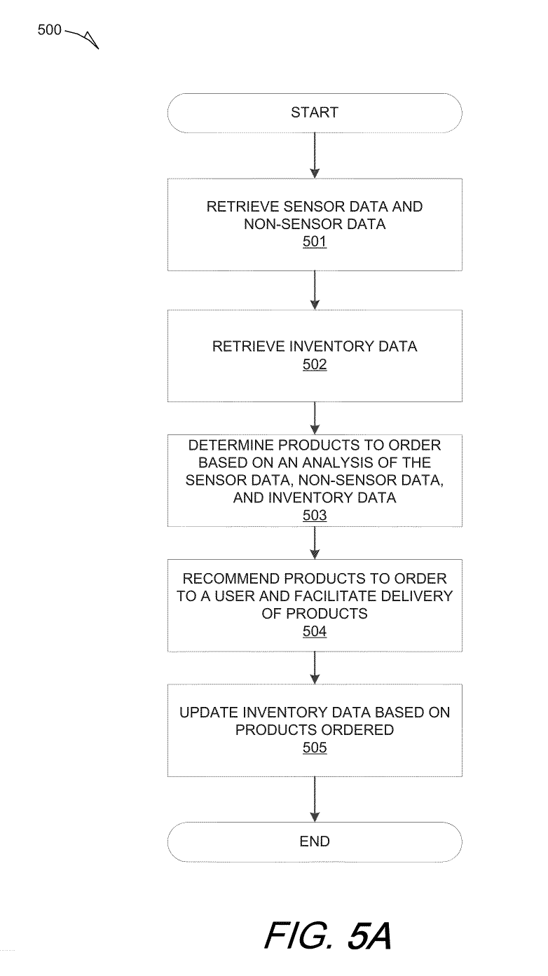

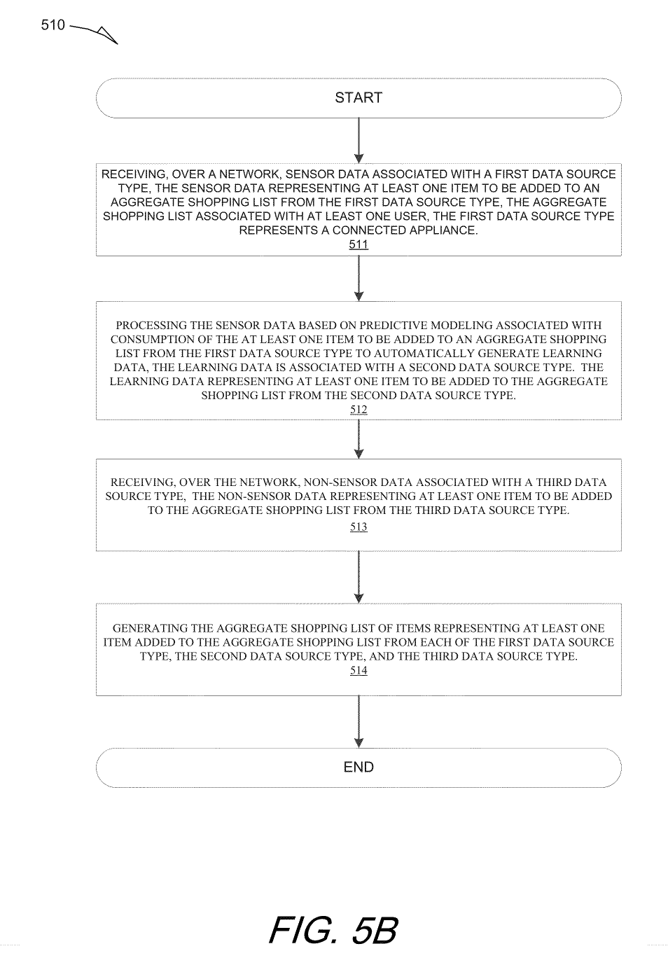

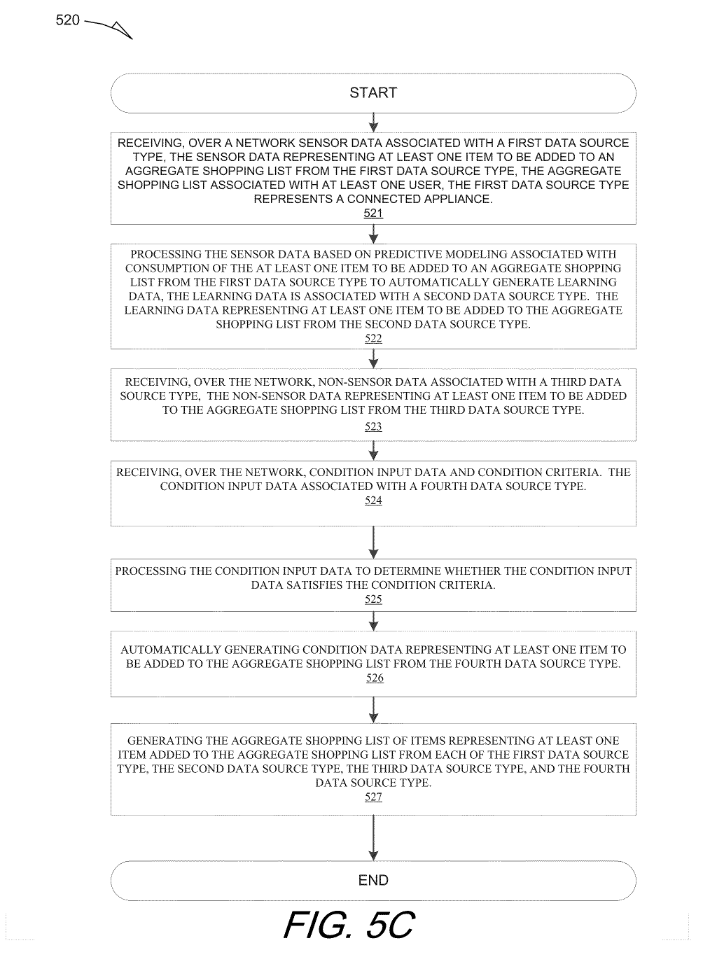

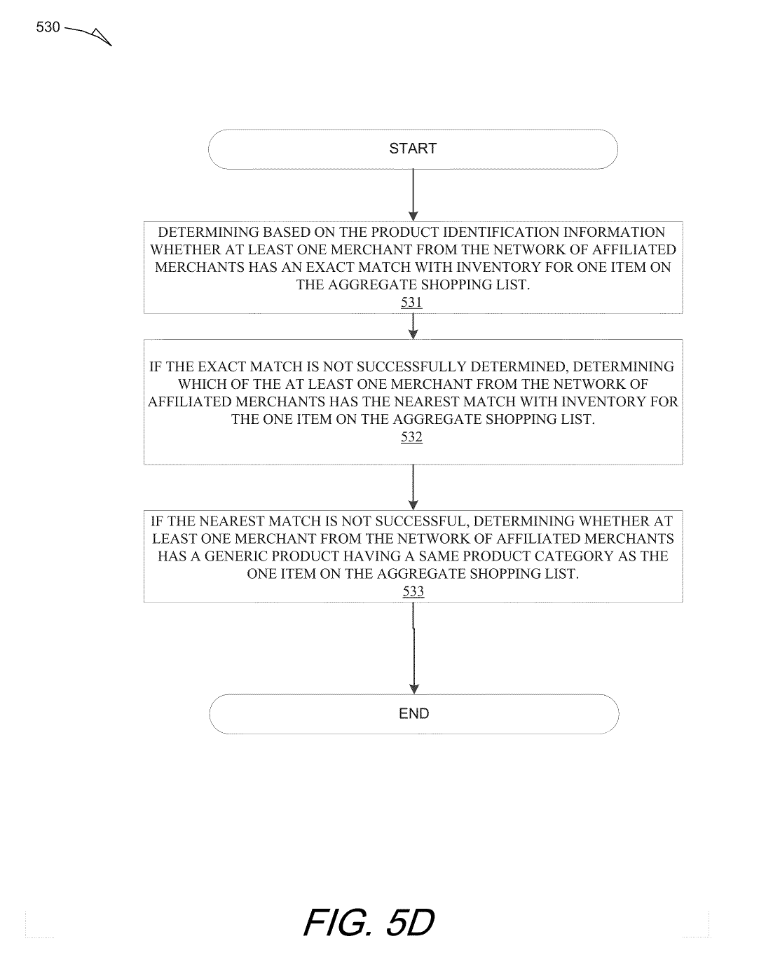

FIG. 5A is a flow diagram illustrating an example method for automatically recommending a product to order based on an analysis of sensor data, non-sensor data, and inventory data. As shown in FIG. 5A, the flow diagram 500 includes operations 501-505. In an embodiment, sensor data and the non-sensor data may be retrieved at operation 501. The sensor data may be retrieved via a number of different means. In an example embodiment, the sensor data is communicated from a network 104. Network communication may operate over near field communication (NFC), WiFi, Bluetooth, or other means of wired or wireless data transmission. In some embodiments, the network communication is via network 104 (e.g., the Internet). In other embodiments, the network communication may be peer-to-peer. In yet other embodiments, the communicate may be via NFC, Bluetooth low energy (BLE), RFID tag, audio, infrared, or other physical means of data transmission. The sensor data may be retrieved from numerous types of sensors. For example, light sensors, image sensors, tactile sensors, temperature sensors, moisture sensors, motion sensors, and so forth.

For example, a refrigerator may have an image sensor implemented inside that may capture images of the contents of the refrigerator. Image recognition software or hardware may then be used to identify products in the refrigerator along with other information such as quantity, brand, and so forth.

Operation 502 may retrieve inventory data. Inventory data may be stored in, for example, databases 126. Inventory data may include a wide variety of information. For example, inventory data may include a product and quantity. In further embodiments, the inventory data may include information about the products such as expiration dates, product brand names, past product brand name purchases, price, weight, dimensions, seasonal sales of the product, color, and so forth.

Operation 503 may determine products to order based on an analysis of the sensor data, non-sensor data, and the inventory data. For example, operation 501 may retrieve sensor data from a refrigerator that indicates a low quantity of eggs. Then, operation 502 may retrieve inventory data related to eggs and determine that there are no other eggs in other refrigerators in a home, the current eggs are past expiration and likely spoiled, the eggs are grade A, in the past only grade A eggs were purchased, on average one dozen eggs per week are purchased, and so forth. An analysis of the inventory data and the sensor data may be used to determine that one dozen grade A eggs should be ordered this week, for example. In further embodiments, other information may be incorporated into the analysis such as the user's historical purchases, current trends in various products, information retrieved from social networks, and other information.

Operation 504 may recommend products to order to a user and facilitate the delivery of products. The user may purchase products using the checkout application 334, for example. The products may be recommended using a variety of UIs. In an example embodiment, the product may be added to a shopping cart and the contents of the shopping cart presented to the user. In other embodiments, a variety of comparable products may be recommended to the user and the user may make a selection by comparing the products. Product information may be retrieved from applications servers. The product information may include product price, product images, brand name, current discounts, and so forth.

In some embodiments, the product recommendations may be based on other information such as ingredients for a recipe, products that are consistent with a particular meal plan, products that are consistent with particular dietary restrictions, products that are consistent with particular medical conditions (e.g., diabetes or allergies), and so forth.

After recommending the products to the user, operation 504 may facilitate the delivery of the products to the user using delivery service module 336 for example. For example, if a user places an order for a product, operation 504 may provide status updates and notifications of the product delivery status. The product status may be retrieved from the third party application servers 130, in an example embodiment. The delivery status may be presented to the user, for example, as a position of the product on a map.

Notifications may be sent using a variety of means. For example, notifications may be delivered using electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Operation 505 may update inventory data based on products ordered. For example, once a user has made a purchase, the inventory may be updated to reflect the purchase. Other data associated with the purchase may also be stored (for example, the time of purchase, brand name, price, whether the product was discounted, if a coupon was used, and so forth). The data may be stored in databases 126, for example.

FIGS. 5B-5D illustrate flow diagrams for various embodiments to dynamically generate aggregate shopping lists. In various embodiments, additional operations may be added to each of the flow diagrams 510-530, or one or more operations may be deleted from each of the flow diagrams 510-530. In further embodiments, the operation flow diagrams 510-530, or variants of these flow diagrams, may be combined.

FIG. 5B is a flow diagram illustrating a method of dynamically generating aggregate shopping lists, according to an example embodiment. The flow diagram 510 includes operations 511-514. For one embodiment, the operations 511-514 may be implemented by one or more systems, modules, or components of the networked system 102. For example, the operations 511-514 may be implemented by the dynamic list system 146 in combination with the merchant inventory system 150.

At operation 511, sensor data associated with a first data source type is received from a network 104. The sensor data represents at least one item to be added to an aggregate shopping list from the first data source type, with the aggregate shopping list associated with at least one user, and the first data source type representing a connected appliance.

At operation 512, the sensor data is processed based on predictive modeling associated with consumption of the at least one item to be added to an aggregate shopping list from the first data source type to automatically generate learning data. The learning data is associated with a second data source type. The learning data represents at least one item to be added to the aggregate shopping list from the second data source type.

At operation 513, non-sensor data associated with a third data source type is received from the network 104. The non-sensor data represents at least one item to be added to the aggregate shopping list from the third data source type.

At operation 514, the aggregate shopping list of items is generated, representing at least one item added to the aggregate shopping list from each of the first data source type, the second data source type, and the third data source type.

FIG. 5C is a flow diagram illustrating a method of dynamically generating aggregate shopping lists, according to another example embodiment. The flow diagram 520 includes operations 521-527. For one embodiment, the operations 521-527 may be implemented by one or more systems, modules, or components of the networked system 102. For example, the operations 521-527 may be implemented by the dynamic list system 146 in combination with the merchant inventory system 150.

At operation 521, the method includes receiving, from a network, sensor data associated with a first data source type. The sensor data represents at least one item to be added to an aggregate shopping list from the first data source type, with the aggregate shopping list associated with at least one user. The first data source type represents a connected appliance.

At operation 522, the method includes processing the sensor data based on predictive modeling associated with consumption of the at least one item to be added to an aggregate shopping list from the first data source type to automatically generate learning data. The learning data is associated with a second data source type. The learning data represents at least one item to be added to the aggregate shopping list from the second data source type.

At operation 523, the method includes receiving, over the network, non-sensor data associated with a third data source type. The non-sensor data represents at least one item to be added to the aggregate shopping list from the third data source type.

At operation 524, the method includes receiving, over the network, condition input data and condition criteria. The condition input data is associated with a fourth data source type. At operation 525, the method includes processing the condition input data to determine whether the condition input data satisfies the condition criteria. At operation 526, the method includes automatically generating condition data representing at least one item to be added to the aggregate shopping list from the fourth data source type.

At operation 527, the method includes generating the aggregate shopping list of items representing at least one item added to the aggregate shopping list from each of the first data source type, the second data source type, the third data source type, and the fourth data source type.

FIG. 5D is a flow diagram illustrating a method of matching items added to a shopping list with merchant inventory, according to an example embodiment. The flow diagram 530 includes operations 531-533. For one embodiment, the operations 531-533 may be implemented by one or more systems, modules, or components of the networked system 102. For example, the operations 531-533 may be implemented by the dynamic list system 146 in combination with the merchant inventory system 150. In other examples, the operation of the operations 531-533 may be implemented by the merchant inventory system 150 or the merchant system 302.

At operation 531, the method includes determining, based on the product identification information, whether at least one merchant from the network of affiliated merchants has an exact match with inventory for one item on the aggregate shopping list. At operation 532, if the exact match is not successfully determined, the method includes determining which of the at least one merchant from the network of affiliated merchants has the nearest match with inventory for the one item on the aggregate shopping list. At operation 533, if the nearest match is not successful, the method includes determining whether at least one merchant from the network of affiliated merchants has a generic product having a same product category as the one item on the aggregate shopping list.

FIG. 6A depicts an example embodiment UI. The UI 601 depicts a list of products that may need to be ordered. A display 602 depicts an example location of where the UI 601 may be located. In this example embodiment, the UI 601 may be on the front of a refrigerator. The UI element 603 may be an electronic shopping cart that displays the number of items in the cart and the total order value. UI element 604 may be a button that when activated will respond to voice commands. The voice commands may, for example, place additional items on a shopping list or place and order.

FIG. 6B depicts an example embodiment UI. UI element 605 depicts an example UI that may be used to add items to an electronic shopping cart and place an order from an online market place (e.g., eBay). UI element 606 may be a button that when activated adds an item to a shopping cart. A variety of metadata related to the products may be displayed in UI element 605. Many brands may be compared on this UI. A price comparison and feature comparison of the products may additional be displayed. Any current promotion or discount may also be displayed in UI element 605. This UI may be used to recommend products to purchases as described herein.

FIG. 6C depicts an example embodiment UI. UI element 607 depicts an example UI that may display items that have been added to an electronic shopping cart. In this example, eggs have been added to the shopping cart. UI element 608 may be a button that when activated may initiate purchase and delivery of the items in the electronic shopping cart, in an example embodiment.

FIG. 6D depicts an example embodiment UI. The UI 609 may display the current delivery status of an order. UI element 610 may display the current location of the products on a map relative to the destination location 611. Status area 612 may be a graphical display of the current order status.

FIG. 6E depicts an example embodiment UI. The UI 613 may display that the delivery is completed or that delivery is imminent. UI element 614 may graphically display that the delivery is completed or about to be completed on a map. Notifications of the impending delivery may be provided.

FIG. 6F depicts an example embodiment UI. The UI 615 may display a shopping list of items to be purchased. Upon completion of a previous order, the shopping list may be dynamically updated to indicate that a product on the list has been order and may no longer need to be on the shopping list.

### Modules, Components, and Logic

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Applications

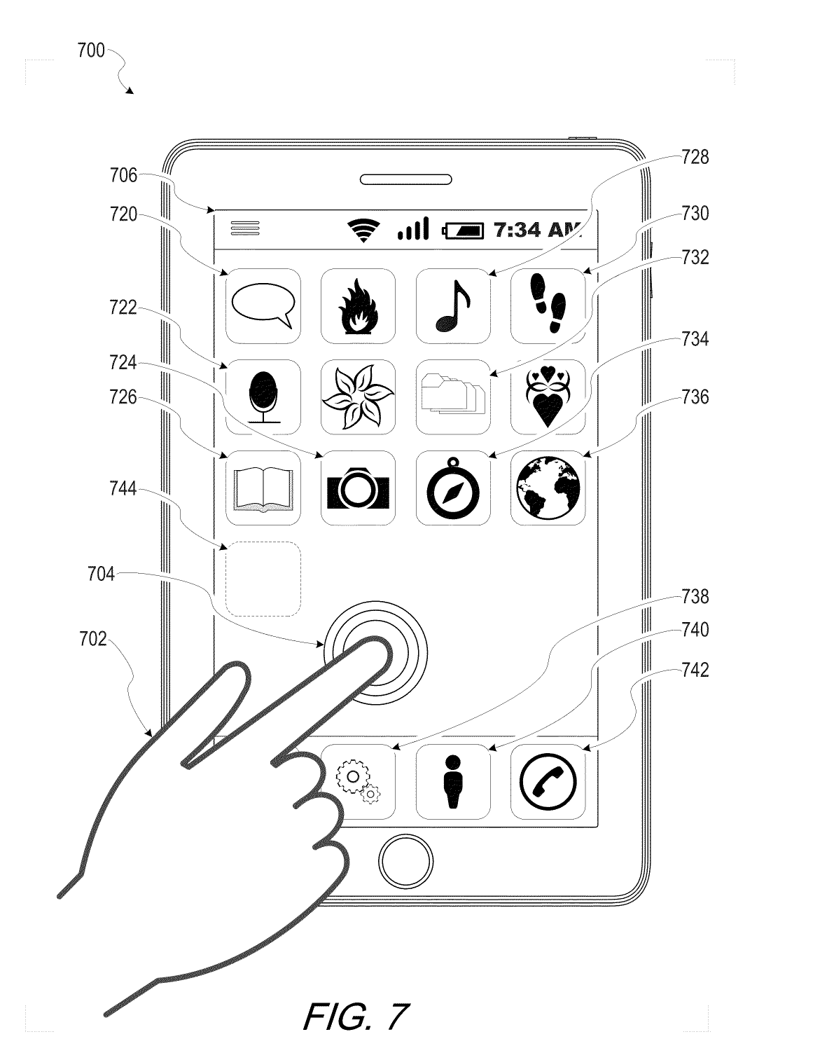

FIG. 7 illustrates an example mobile device that may be executing a mobile operating system (e.g., iOS™, Android™, Windows® Phone, or other mobile operating systems), according to example embodiments. In one embodiment, the mobile device 700 may include a touch screen that may receive tactile information from a user 702. For instance, the user 702 may physically touch 704 the mobile device 700, and in response to the touch 704, the mobile device 700 may determine tactile information such as touch location, touch force, gesture motion, and so forth. In various example embodiments, the mobile device 700 may display home screen 706 (e.g., Springboard on iOS™) that the user 702 of the mobile device 700 may use to launch applications and otherwise manage the mobile device 700. In various example embodiments, the home screen 706 may provide status information such as battery life, connectivity, or other hardware status. The home screen 706 may also include a plurality of icons that may be activated to launch applications, for example, by touching the area occupied by the icon. Similarly, other UI elements may be activated by touching an area occupied by a particular UI element. In this manner, the user 702 may interact with the applications.

Many varieties of applications (also referred to as “apps”) may be executing on the mobile device 700. The applications may include native applications (e.g., applications programmed in Objective-C running on iOS™ or applications programmed in Java running on Android™), mobile web applications (e.g., HTML5), or hybrid applications (e.g., a native shell application that launches an HTML5 session). In a specific example, the mobile device 700 may include a messaging app 720, audio recording app 722, a camera app 724, a book reader app 726, a media app 728, a fitness app 730, a file management app 732, a location app 734, a browser app 736, a settings app 738, a contacts app 740, a telephone call app 742, other apps (e.g., gaming apps, social networking apps, biometric monitoring apps), a third party app 744, and so forth. Examples of other apps may include a shopping list app, a recipe app, a note taking app such as Evernote, a productivity app that allows tracking tasks and lists, a shopping app which includes shopping list functionality, or other apps which include shopping list functionalities.

### Software Architecture

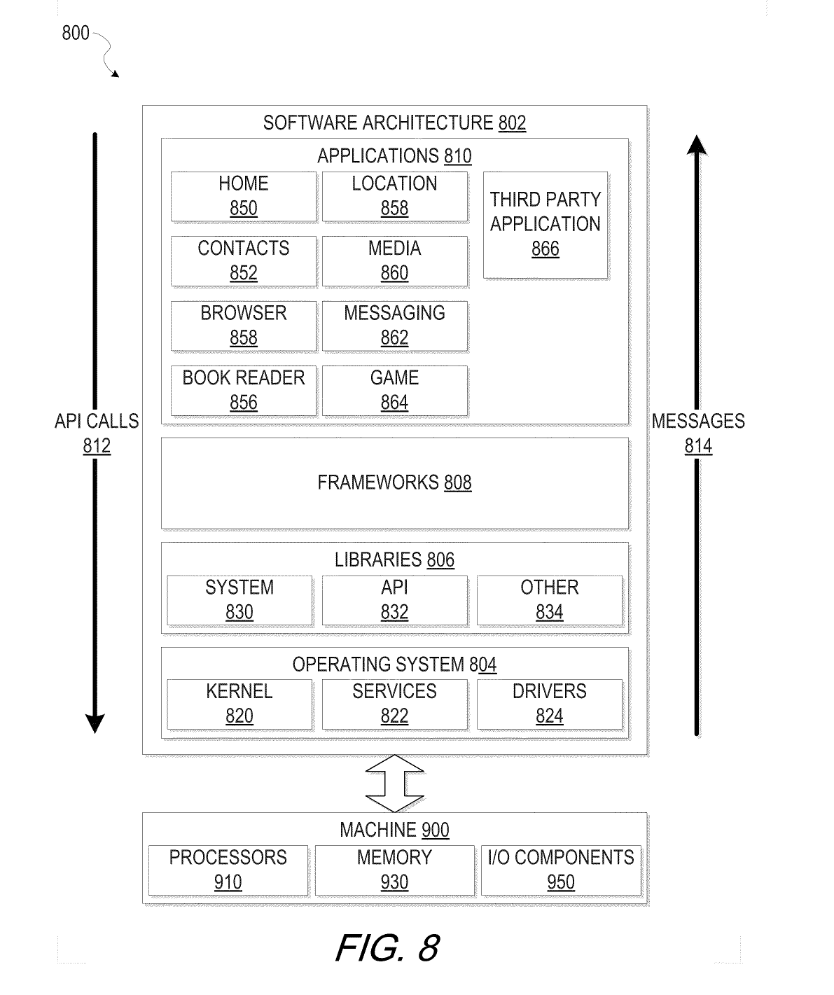

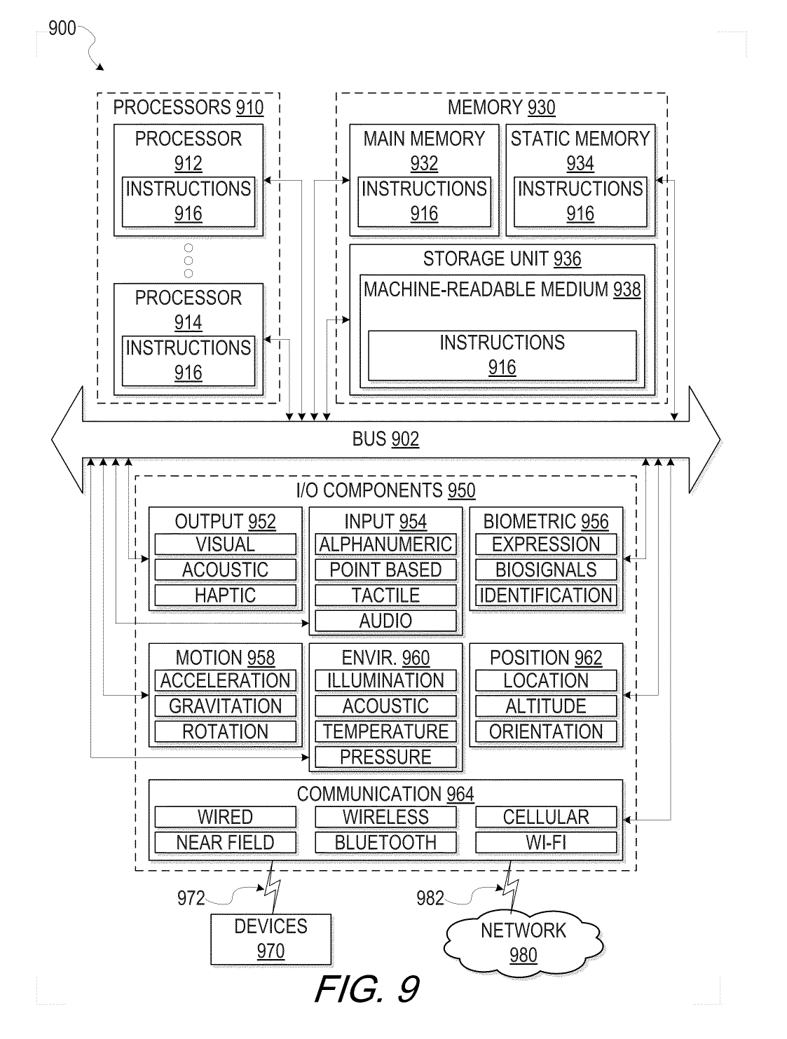

FIG. 8 is a block diagram 800 illustrating an architecture of software 802, which may be installed on any one or more of devices described above. FIG. 8 is merely a non-limiting example of a software architecture and it will be appreciated that many other architectures may be implemented to facilitate the functionality described herein. The software 802 may be executing on hardware such as machine 900 of FIG. 9 that includes processors 910, memory 930, and input/output (I/O) components 950. In the example architecture of FIG. 8, the software 802 may be conceptualized as a stack of layers where each layer may provide particular functionality. For example, the software 802 may include layers such as an operating system 804, libraries 806, frameworks 808, and applications 810. Operationally, the applications 810 may invoke API calls 812 through the software stack and receive messages 814 in response to the API calls 812.

The operating system 804 may manage hardware resources and provide common services. The operating system 804 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 806 may provide a low-level common infrastructure that may be utilized by the applications 810. The libraries 806 may include system libraries 830 (e.g., C standard library) that may provide functions such as memory allocation functions, string manipulation functions, mathematic functions, and the like. In addition, the libraries 806 may include API libraries 832 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 806 may also include a wide variety of other libraries 834 to provide many other APIs to the applications 810.

The frameworks 808 may provide a high-level common infrastructure that may be utilized by the applications 810. For example, the frameworks 808 may provide various UI functions, high-level resource management, high-level location services, and so forth. The frameworks 808 may provide a broad spectrum of other APIs that may be utilized by the applications 810, some of which may be specific to a particular operating system or platform.

The applications 810 include a home application 850, a contacts application 852, a browser application 854, a book reader application 856, a location application 858, a media application 860, a messaging application 862, a game application 864, and a broad assortment of other applications such as third party application 866. In a specific example, the third party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 866 may invoke the API calls 812 provided by the mobile operating system 804 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 912 and processor 914, which may execute instructions 916. The term “processor” is intended to include multi-core processors that may comprise two or more independent processors (also referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory 930 may include a main memory 932, a static memory 934, and a storage unit 936 accessible to the processors 910 via the bus 902. The storage unit 936 may include a machine-readable medium 938 on which is stored the instructions 916 embodying any one or more of the methodologies or functions described herein. The instructions 916 may also reside, completely or at least partially, within the main memory 932, within the static memory 934, within at least one of the processors 910 (e.g., within the processor's cache memory), or any suitable combination thereof, during execution thereof by the machine 900. Accordingly, the main memory 932, static memory 934, and the processors 910 may be considered as machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown in an example embodiment to be a single medium, the term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 950 may include a wide variety of components to receive input, provide output, produce output, transmit information, exchange information, capture measurements, and so on. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, NFC components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include RFID tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a POTS network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

Furthermore, the machine-readable medium 938 is non-transitory (in other words, not having any transitory signals) in that it does not embody a propagating signal. However, labeling the machine-readable medium 938 as “non-transitory” should not be construed to mean that the medium is incapable of movement; the medium should be considered as being transportable from one physical location to another. Additionally, since the machine-readable medium 938 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a network, sensor data associated with a first data source type, the sensor data representing at least one item to be added to an aggregate list from the first data source type, the aggregate list associated with at least one user, the first data source type representing a connected appliance;
processing, using at least one processor, the sensor data based on predictive modeling associated with a consumption of the at least one item to be added to the aggregate list from the first data source type to automatically generate learning data, the learning data associated with a second data source type and representing at least one item to be added to the aggregate list from the second data source type;
receiving, from the network, non-sensor data associated with a third data source type, the non-sensor data representing at least one item to be added to the aggregate list from the third data source type;
generating the aggregate list of items representing at least one item added to the aggregate list from each of the first data source type, the second data source type, and the third data source type.

2. The method of claim 1, further comprising:
receiving, from the network, condition input data and condition criteria, the condition input data associated with a fourth data source type;
processing, using at least one processor, the condition input data to determine whether the condition input data satisfies the condition criteria;
automatically generating, using at least one processor, condition data representing at least one item to be added to the aggregate list from the fourth data source type.

3. The method of claim 2, wherein the learning data for the at least one item to be added to the aggregate list may be overridden by condition data.

4. The method of claim 2, wherein generating the aggregate list further comprises:
generating the aggregate list of items representing at least one item added to the aggregate list from each of the first data source type, the second data source type, the third data source type, and the fourth data source type.

5. The method of claim 1, wherein the third data source type includes one or more persons associated with the at least one user; and
wherein the non-sensor data includes user specified data representing the at least one item to be added to the aggregate list from the one or more persons.

6. The method of claim 1, wherein the sensor data includes the at least one item to be added to the aggregate list and associated product identification information.

7. The method of claim 6, wherein the product identification information includes a stock keeping unit (SKU) number of the at least one item on the aggregate list.

8. The method of claim 7, wherein the SKU number is used by a merchant inventory system associated with a network of affiliated merchants to determine whether one or more affiliated merchants has available inventory of the at least one item on the aggregate list.

9. The method of claim 6, further comprising:
determining, based on the product identification information, whether at least one merchant from the network of affiliated merchants has an exact match with inventory for one item on the aggregate list;
if the exact match is not successfully determined, determining which of the at least one merchant from the network of affiliated merchants has a nearest match with inventory for the one item on the aggregate list; and
if the nearest match is not successful, determining whether at least one merchant from the network of affiliated merchants has a generic product having a same product category as the one item on the aggregate list.

10. The method of claim 1, wherein the receiving, from the network, the non-sensor data further comprises:
retrieving the non-sensor data from a cloud computing environment, the cloud computing environment hosting a list application accessible by a client device, the non-sensor data received by the list application through the client device.

11. The method of claim 1, further comprising:
identifying available inventory for the at least one item on the aggregate list from one or more merchants within a network of affiliated merchants.

12. The method of claim 11, further comprising:
identifying available advertising discounts associated with the at least one item on the aggregate list offered by one or more merchants within the network of affiliated merchants.

13. The method of claim 1, wherein the second data source type represents a learning machine.

14. The method of claim 1, wherein the third data source type represents a list application.

15. The method of claim 1,
further comprising: receiving, from the network, non-sensor data associated with a fifth data source type, the non-sensor data representing at least one item to be added to the aggregate list from the fifth data source type, the fifth data source type representing a recipe application; and
wherein generating the aggregate list further comprises: generating an aggregate list of items representing at least one item added from each of the first data source type, the second data source type, the third data source type, and the fifth data source type.

16. A system to manage system resources, comprising:
at least one processor configured to perform operations for processor-implemented modules including:
an inventory management system configured to:
receive sensor data associated with a first data source type, the sensor data representing at least one item to be added to an aggregate list from the first data source type, the aggregate list associated with at least one user, the first data source type representing a connected appliance; and
non-sensor data associated with a third data source type, the non-sensor data representing at least one item to be added to the aggregate list from the third data source type;
a learning machine configured to process the sensor data based on predictive modeling associated with consumption of the at least one item to be added to the aggregate list from the first data source type to automatically generate learning data, the learning data associated with a second data source type and representing at least one item to be added to the aggregate list from the second data source type; and
an aggregate list generation system configured to generate the aggregate list of items representing at least one item added to the aggregate list from each of the first data source type, the second data source type, and the third data source type.

17. The system of claim 16, further comprising:
a condition system configured to:
receive condition input data and condition criteria, the condition input data associated with a fourth data source type;
process the condition input data to determine whether the condition input data satisfies the condition criteria; and
automatically generate condition data representing at least one item to be added to the aggregate list from the fourth data source type.

18. The system of claim 16, further comprising:
a merchant inventory system configured to identify available inventory for the at least one item on the aggregate list from one or more merchants within the network of affiliated merchants.

19. The system of claim 18, further comprising:
an advertising generation module configured to identify available advertising discounts associated with the at least one item on the aggregate list offered by one or more merchants within the network of affiliated merchants.

20. A non-transitory machine readable medium storing instructions that, when executed by at least one processor of a machine, cause the machine to perform operations comprising:
receiving sensor data associated with a first data source type, the sensor data representing at least one item to be added to an aggregate list from the first data source type, the aggregate list associated with at least one user, the first data source type representing a connected appliance;
processing the sensor data based on predictive modeling associated with consumption of the at least one item to be added to the aggregate list from the first data source type to automatically generate learning data, the learning data associated with a second data source type and representing at least one item to be added to the aggregate list from the second data source type;
receiving non-sensor data associated with a third data source type, the non-sensor data representing at least one item to be added to the aggregate list from the third data source type; and
generating the aggregate list of items representing at least one item added to the aggregate list from each of the first data source type, the second data source type, and the third data source type.
